(19) United States
(12) Patent Application Publication
(10) Pub. No.: US 2010/0038101 A1
(43) Pub. Date: Feb. 18, 2010

(54) FIRE EXTINGUISHMENT SYSTEMS AND NOZZLES

(75) Inventors: Roger G. Terry, Aurora, CO (US); Michael P. Hancock, Centennial, CO (US); Don Dwayne Lyles, Centennial, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Advanced Fire Control Technologies, Inc., Littleton, CO (US)

(21) Appl. No.: 12/541,101

(22) Filed: Aug. 13, 2009

Related U.S. Application Data
(60) Provisional application No. 61/088,717, filed on Aug. 13, 2008.
(60) Provisional application No. 61/101,087, filed on Sep. 29, 2008.
(60) Provisional application No. 61/118,090, filed on Nov. 26, 2008.

(51) Int. Cl. A62C 31/02

(52) U.S. Cl. 169/70

(57) ABSTRACT

A fire extinguishment system may include a fire extinguishment apparatus joined to dry chemical, clean agent and water systems. The fire extinguishment apparatus may include dry chemical, clean agent and water nozzles joined to a housing. The dry chemical nozzle may be a multi-stage nozzle configured to discharge consolidated dry chemical with a substantial charge. The dry chemical nozzle may include chamber segments formed from aluminum, collars formed from stainless steel and positioned between the chamber segments, and a flow disruptor. At least some chamber segments may include rifled surfaces. The dry chemical nozzle may be positioned within the water nozzle to allow water discharged from the water nozzle to at least partially encompass dry chemical discharged from the dry chemical nozzle or positioned offset from the water nozzle to allow for parallel discharge of water and dry chemical streams from the fire extinguishment apparatus.

### CROSS-REFERENCE TO RELATED APPLICATIONS

This application claims under 35 U.S.C. §119(e) the benefit of U.S. provisional application No. 61/088,717, entitled “FIRE EXTINGUISHMENT APPARATUS,” and filed on Aug. 13, 2008; U.S. provisional application No. 61/101,087, entitled “FIRE EXTINGUISHMENT APPARATUS,” and filed on Sep. 29, 2008; and U.S. provisional application No. 61/118,090, entitled “FIRE EXTINGUISHMENT APPARATUS” and filed on Nov. 26, 2008; each of which are hereby incorporated by reference herein in their entireties.

### FIELD OF INVENTION

The present invention generally relates to fire equipment, and more particularly to a fire extinguishment system.

### BACKGROUND

When fighting a fire, environmental factors, such as ambient air resistance and turbulence and varying pressures created by the fire being fought, can make it difficult to deliver effective quantities of dry chemicals and clean agents in order to fight the fire from a safe distance. Further, the tremendous heat generated by a typical fire can create high wind currents and turbulence that can render the delivery of loosely clumped dry chemicals and clean agents ineffective. Accordingly, what is needed in the art is a fire extinguishment system that can effectively deliver dry powders and clean agents at a safe distance from a fire.

### BRIEF SUMMARY

One embodiment of the present invention may take the form of a fire extinguishment nozzle assembly. The fire extinguishment nozzle assembly may include a nozzle. The nozzle may include a first chamber segment and a first collar. The first chamber segment may include an inlet configured to receive a dry chemical and an outlet. The first chamber segment may define a dry chemical passage extending from the inlet to the outlet. The first collar may include an inlet side and an outlet side and may define a first aperture extending from the inlet side to the outlet side. The first aperture may be larger at the inlet side than at the outlet side. The first aperture may be in fluid communication with the outlet of the first chamber segment. In some embodiments, the dry chemical passage may include a first cross-sectional area proximate the inlet and a second cross-sectional area proximate the outlet, and the first cross-sectional area may be smaller than the second cross-sectional area. In some embodiments, the nozzle may include second and third chamber segments similar to the first chamber segment and may include second and third collars similar to the first collar.

Another embodiment of the present invention may take the form of a fire extinguishment nozzle assembly. The fire extinguishment nozzle assembly may include a nozzle. The nozzle may be configured such that a substantially non-polarized dry chemical delivered from a dry chemical source to the nozzle at a pressure greater that approximately 250 pounds per square inch exits the nozzle with a charge of at least approximately 30,000 volts. In some embodiments of this fire extinguishment nozzle assembly, the nozzle includes two chamber segments and a collar. The two chamber segments define at least a portion of a dry chemical passage. The collar may be positioned between the two chamber segments and define an aperture that enables fluid communication between the at least two chamber segments.

Yet another embodiment of the present invention may take the form of a fire extinguishment nozzle assembly. The fire extinguishment nozzle assembly may include a first nozzle and a second nozzle. The first nozzle may be configured to deliver dry chemical in a consolidated dry chemical stream from the first nozzle. The second nozzle may be configured to deliver a water stream that selectively at least partially encompasses the consolidated dry chemical stream. In some embodiments of this fire extinguishment nozzle assembly, the second nozzle defines a fluid passage and the first nozzle is at least partially contained within the fluid passage. In some other embodiments of this fire extinguishment nozzle assembly, the nozzle includes a chamber segment and a collar. The chamber segment may include an inlet configured to receive a dry chemical and an outlet. The chamber segment may define a dry chemical passage extending from the inlet to the outlet. The collar may be positioned proximate the outlet of the chamber segment. The collar may include an inlet side and an outlet side. The collar may define an aperture extending from the inlet side to the outlet side with the aperture larger at the inlet side than at the outlet side. The aperture may be in fluid communication with the outlet of the chamber segment.

Still yet another embodiment of the present invention may take the form of a fire extinguishment apparatus. The fire extinguishment apparatus may include a housing, a first nozzle, a second nozzle, and a third nozzle. The first nozzle may be at least partially contained within the housing. The first nozzle may be configured to deliver at least a dry chemical. The second nozzle may be operatively associated with the housing. The second nozzle may be configured to deliver at least water. The third nozzle may operatively associated with the housing. The third nozzle may be configured to deliver at least clean agent. In some embodiments of this fire extinguishment apparatus, the first nozzle may further include at least three chamber segments. In such embodiments, each chamber segment may define a chamber, and each chamber may be in communication with at least one other chamber. In yet further embodiments of this fire extinguishment apparatus, the first nozzle may further include a collar positioned between two of the at least three chamber segments. The collar may include an aperture enabling fluid communication between the two chamber segments.

Another embodiment of the present invention may take the form of a fire extinguishment system. The fire extinguishment system may include a fire extinguishment apparatus, a dry chemical system, a clean agent system, and a water system. The dry chemical system may include a pressurized dry chemical tank operatively associated with the fire extinguishment apparatus. The clean agent system may include a clean agent tank operatively associated with the fire extinguishment apparatus. The water system may include a water source operatively associated with the fire extinguishment apparatus. In some embodiments of this fire extinguishment system, the fire extinguishment system may further include a dry chemical hose operatively associated with the dry chemical tank and the fire extinguishment apparatus. Some of these embodiments may include a dry chemical nozzle operatively associated with the dry chemical hose. In such embodiments, at least one of the dry chemical hose and dry chemical nozzle may be configured to polarize dry chemical flowing therethrough. In some embodiments of the fire extinguishment system, the pressured dry chemical tank may be maintained at a pressure between approximately 250 and 500 pounds per square inch (“psi”).

### BRIEF DESCRIPTION OF THE DRAWINGS

FIG. 1 depicts a perspective view of an example of a fire extinguishment apparatus or nozzle assembly.

FIG. 2 depicts a cross-section view of the fire extinguishment apparatus of FIG. 1, viewed along line 2-2 in FIG. 1.

FIG. 3 depicts an enlarged partial cross-section view of a portion of the fire extinguishment apparatus of FIG. 1.

FIG. 4 depicts a cross-section view of the fire extinguishment apparatus of FIG. 1, viewed along line 4-4 in FIG. 1.

FIG. 5 depicts another cross-section view of the fire extinguishment apparatus of FIG. 1, similar to the view shown in FIG. 2, with a clean agent valve shown in an open position.

FIG. 6 depicts another cross-section view of the fire extinguishment apparatus of FIG. 1, similar to the view shown in FIG. 2, with a dry chemical valve shown in an open position.

FIG. 7 depicts another cross-section view of the fire extinguishment apparatus of FIG. 1, similar to the view shown in FIG. 2, with a water valve shown in an open position.

FIG. 8 depicts an exploded perspective view of a dry chemical nozzle for the fire extinguishment apparatus shown in FIG. 1.

FIG. 9 depicts another exploded perspective view of the dry chemical nozzle for the fire extinguishment apparatus shown in FIG. 1.

FIG. 10 depicts a cross-section view of a first chamber segment of the dry chemical nozzle and elevation end views of this segment.

FIG. 11 depicts a cross-section view of a second chamber segment of the dry chemical nozzle and elevation end views of this segment.

FIG. 12 depicts a cross-section view of a third chamber segment of the dry chemical nozzle and elevation end views of this segment.

FIG. 13 depicts a cross-section view of a fourth chamber segment of the dry chemical nozzle and elevation end views of this segment.

FIGS. 14A, 14B and 14C depict cross-section views of first, second, and third collars of the dry chemical nozzle and an elevation end view of each collar.

FIGS. 15A, 15B and 15C depict cross-section views of the first, second, and third collars, showing the collars having different dimensions than the collars of FIG. 14.

FIG. 16 depicts a perspective view of another example of a fire extinguishment apparatus or nozzle assembly.

FIG. 17 depicts a top plan view of the fire extinguishment apparatus shown in FIG. 16.

FIG. 18 depicts a cross-section view of the fire extinguishment apparatus of FIG. 16, viewed along line 18-18 in FIG. 17.

FIG. 19 depicts a cross-section view of the fire extinguishment apparatus of FIG. 16, viewed along line 19-19 in FIG. 17.

FIG. 19A depicts a cross-section view similar to the view of FIG. 19, with the dry chemical valve shown in an open position.

FIG. 20 depicts a cross-section view of the fire extinguishment apparatus of FIG. 16, viewed along line 20-20 in FIG. 17.

FIG. 20A depicts a cross-section view similar to the view of FIG. 20, with a trigger shown in an position that opens a clean agent valve and a switch valve shown as aligned with a port in fluid communication with a clean agent nozzle.

FIG. 20B depicts a cross-section view similar to the view of FIG. 20, with the switch valve shown as aligned with a port in fluid communication with a dry chemical nozzle.

FIG. 20C depicts a cross-section view similar to the view of FIG. 20B, with a trigger shown in a position that opens a clean agent valve.

FIG. 21 depicts a cross-section view of the fire extinguishment apparatus of FIG. 16, viewed along line 21-21 in FIG. 20C.

FIG. 22 depicts a cross-section view of the fire extinguishment apparatus of FIG. 16, viewed along line 22-22 in FIG. 17.

FIG. 22A depicts a cross-section view similar to the view of FIG. 21, with the water valve shown in an open position.

FIG. 23 depicts an exploded perspective view of the fire extinguishment apparatus shown in FIG. 16.

FIG. 24 depicts a schematic view of a fire extinguishment system.

### DETAILED DESCRIPTION

Described herein are systems for extinguishing fires. The fire extinguishing systems may include a nozzle system. The nozzle system may deliver streams and/or slugs of water, dry chemical, cleaning agent, foam, or some combination thereof. The dry chemical may be delivered as a consolidated solid particulate stream. The fire extinguishment system may include a pneumatic system for entraining particulate fire fighting agent in a high velocity and high pressure gas stream, separating and consolidating the solid particulate from the high pressure gas stream into consolidated sections, and delivering from a safe distance the consolidated sections in a constant stream at a high rate of speed to the center of the fire being fought.

The fire extinguishment systems may further include a high pressure gas supply, a pressure regulator, an agent storage and fluidizing vessel, and a nozzle system with a multi-stage delivery nozzle capable of separating the solid particulate from the high pressure propulsion and fluidizing gas stream. Particulate agent may be sequentially consolidated and compressed through the multiple nozzle stages by virtue of the continuous focusing of the solid particulate to the center of the stream. This forces the entrained high pressure propulsion gas to the outside of the stream until the gas pressure increases to the point that interruptions of the consolidated solid particulate stream may occur creating a resulting slug and velocity increase of the consolidated section as it leaves the multi-stage nozzle. This physical segregation of the solid particulate and high pressure propulsion gas and the resultant disruption of the solid stream by the gathering high pressure propulsion gas within the chambers creates a ‘machine gun’ like effect of delivering the consolidated sections in consolidated masses of solid particulate void of the majority of the high pressure propulsion gas followed by a separate and distinct high pressure packet of propulsion gas.

Polarization of the dry chemical powder may be achieved through a turbulent high friction and high velocity environment created within the delivery system and the nozzle in particular. This high friction and high velocity environment appears to strip positive or negative charges from the delivered medium (e.g., a dry chemical powder). This resultant electrostatic charge or polarization on and within the delivery system, nozzle, and dry chemical powder is substantial. As used herein, a “substantial charge” generally means an electrostatic charge that is at least approximately 30 kilovolts (“kV”), which represents a lower threshold for measurable fire suppression effects. This substantially charged medium exits the nozzle with an inherent attractive pull to the charged fire plasma (heart of the fire) or its surrounding anionic and free radical environment, which has been characterized (at least in the Northern hemisphere) as a positively charge plasma surrounded by negatively charged anionic and free radicals at the outer edges of the fire envelope. The anionic and free radical environment surrounding the fire plasma is associated with fire propagation.

In some embodiments, the nozzle system may be configured to selectively entrain clean agent gases within the dry chemical stream or to independently deliver the clean agent gases through a clean agent nozzle or outlet. The nozzle system may further be configured to deliver air, water, foam, and/or clean agent at pressures in excess of 350 psi to increase performance in small water droplet delivery, foam expansion and delivery distances.

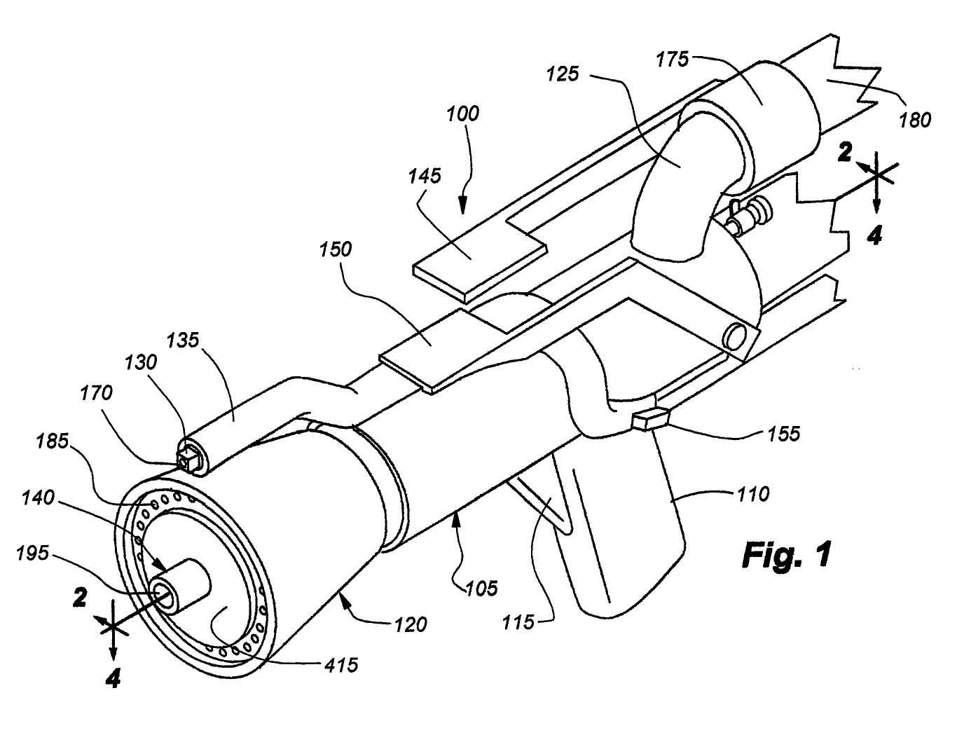

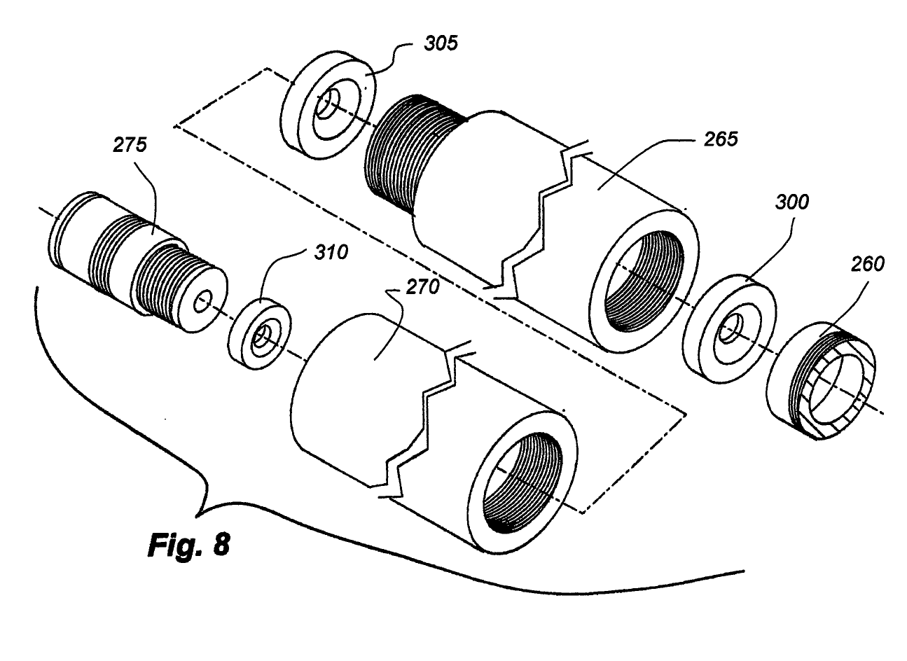

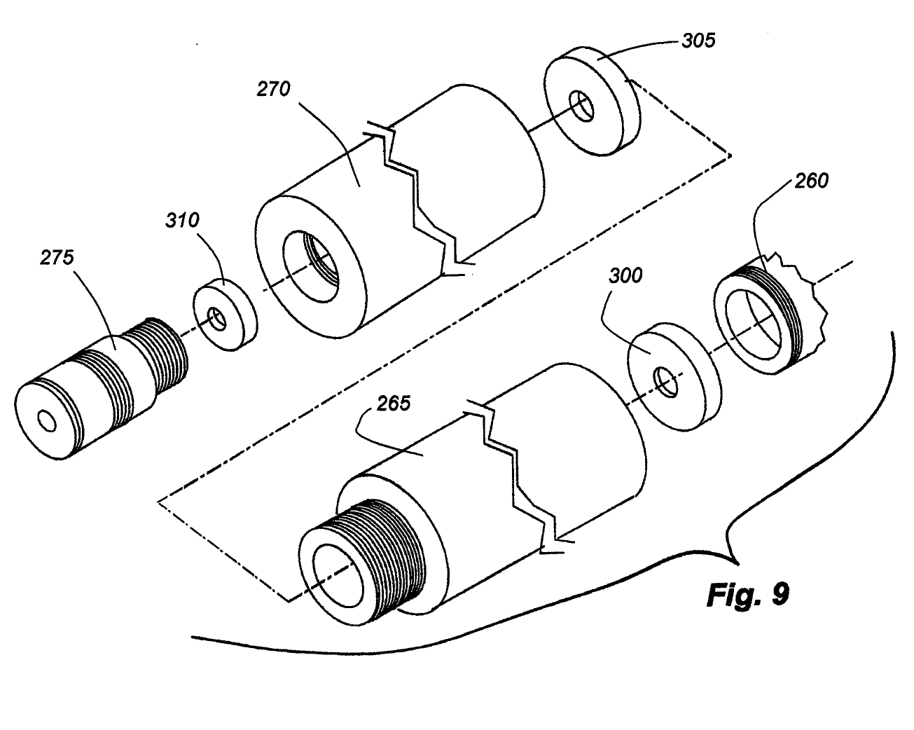

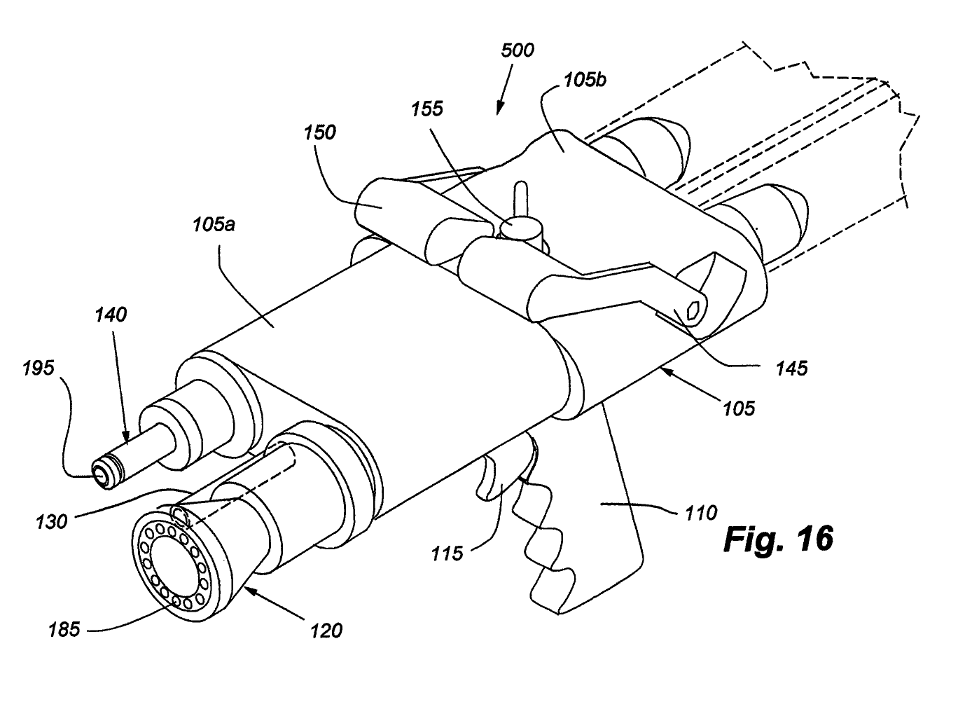

FIGS. 1-9 show various views of an example of a fire extinguishment apparatus 100, which may also be referred to as a fire extinguishment nozzle assembly or a fire extinguishment nozzle system. With reference to FIG. 1, the fire extinguishment apparatus 100 may include a housing 105, a handle 110, a trigger 115, a water nozzle 120, a water conduit 125, a clean agent nozzle 130, a clean agent conduit 135, a dry chemical nozzle 140, a water handle 145, a dry chemical handle 150 and a switch 155. The housing 105 may be generally cylindrical or any other suitable shape that provides for either entrained (as shown, for example, in, FIG. 1) or parallel dry chemical delivery (as shown, for example, in FIG. 16). The housing 105 may be formed from one or more bodies joined by any suitable connection method, such as welding, mechanical fastening, and so on. The handle 110 may extend downwardly from a lower portion of the housing 105. The handle 110 may be integrally formed with the housing 105 to define a unitary body or may be joined to the housing 105 by any suitable connection method, including, without limitation, by mechanical fastening or welding. The handle 110 may be sized to be grasped by a user's hand.

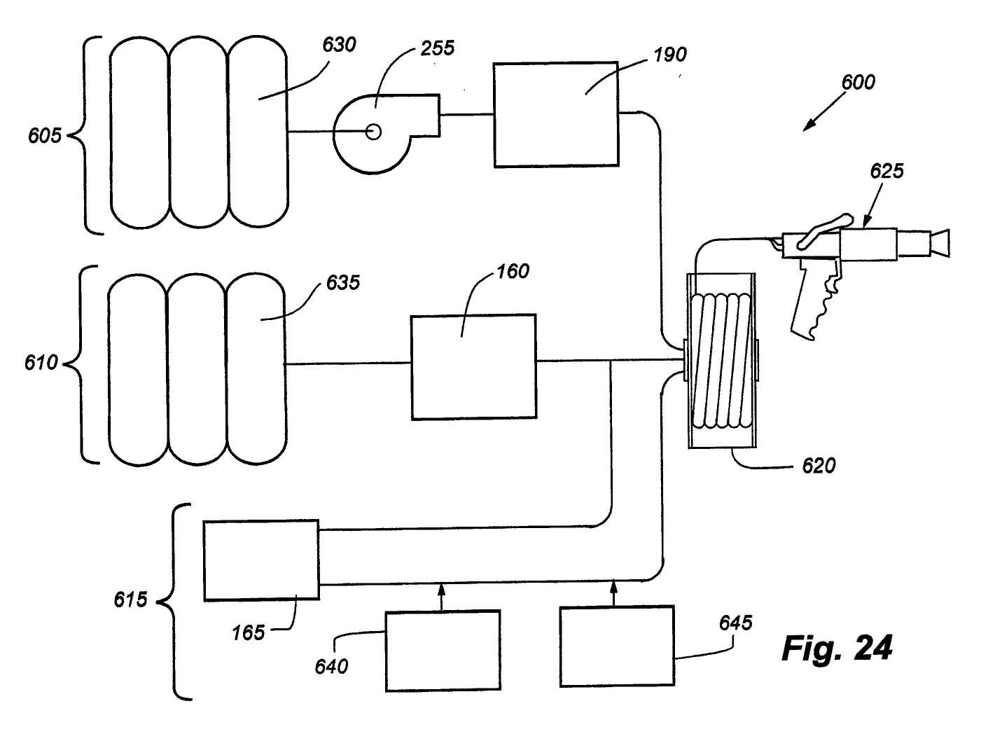

The trigger 115 may be movably joined to the handle 110. The trigger 115 may be used to control flow of a chemical agent, such as halon. More particularly and as described in more detail below, selective movement of the trigger 115 relative to the handle 110 enables and disables communication between a chemical agent source 160 (see FIG. 24 for a schematic of the chemical agent source 160), and/or a water source 165 (see FIG. 24), and the clean agent nozzle 130. When such communication is enabled, the clean agent and/or water exits the fire extinguishment apparatus 100 via a clean agent outlet 170 defined by the clean agent nozzle 130. The clean agent outlet 170 may be circular or any other suitable shape. The clean agent nozzle 130 may have a discharge distance of greater than 30 feet, and may be configured to deliver clean agent, water, or a combination thereof at pressures in excess of 350 psi. In some embodiments, the clean agent nozzle 130 may be configured to deliver clean agent, water, or a combination thereof at pressures between 1000 and 2000 psi. The clean agent nozzle 130 may further be configured to deliver clean agent, water, or a combination thereof at discharge rates of up to 25 gallons per minute.

The water conduit 125 may be integrally formed with the housing 105 to define a unitary body, or may be joined to the housing 105 using any suitable connection method, including mechanical fastening or welding. As described in more detail below, a water conduit connector 175 may join a water hose 180, which may also be referred to as a fluid hose, to the water conduit connector 175. The water hose 180 may, in turn, be fluidly connected to a water source 165 (see FIG. 24 for a schematic of the water source 165). The water handle 145 may be movably joined to the water conduit connector 175. As described in more detail below, selective movement (e.g., rotation) of the water handle 145 relative to the water conduit connector 175 enables and disables fluid communication between the water source 165 and the water nozzle 120. When fluid communication is enabled, water exits the fire extinguishment apparatus 100 via one or more water outlets 185 defined by the water nozzle 120. The water outlets 185 may be circular or any other suitable shape. Water, injected foam or premixed foam may be delivered to a mixing chamber positioned upstream of an inlet portion of the water nozzle 120 in standard operating or ultra high pressure delivery systems to allow the discharge of water, foam, ultra high pressure liquid fog, or some combination thereof from the water nozzle 120 either independently of, or in conjunction with, discharge of the dry chemical and the clean agent from the fire extinguishment nozzle assembly 100.

The dry chemical handle 150 may be movably joined to the housing 105. As described in more detail below, selective movement (e.g., rotation) of the dry chemical handle 150 relative to the housing 105 enables and disables communication between a dry chemical source 190 (see FIG. 24 for a schematic representation of the dry chemical source 190) and the dry chemical nozzle 140. When such communication is enabled, dry chemical exits the fire extinguishment apparatus 100 via a dry chemical outlet 195 defined by the dry chemical nozzle 140. The dry chemical outlet 195 (or outlets) may be circular or any other suitable shape. The dry chemical stream discharged from the dry chemical outlet 195 may be entrained with, parallel to, or independent of the water stream or any other agent stream.

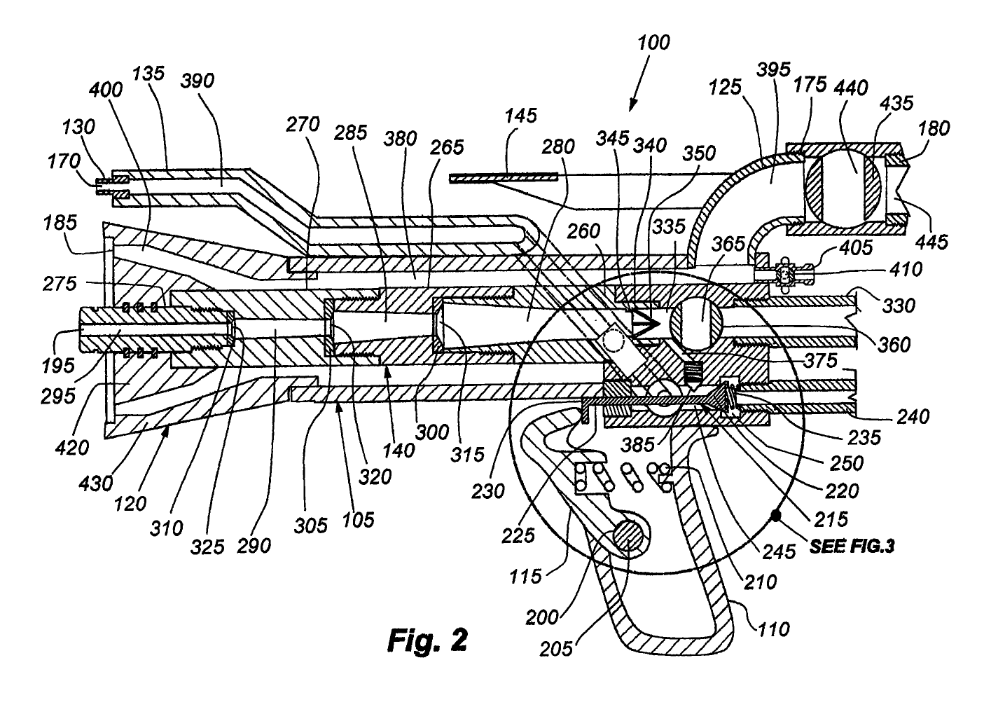

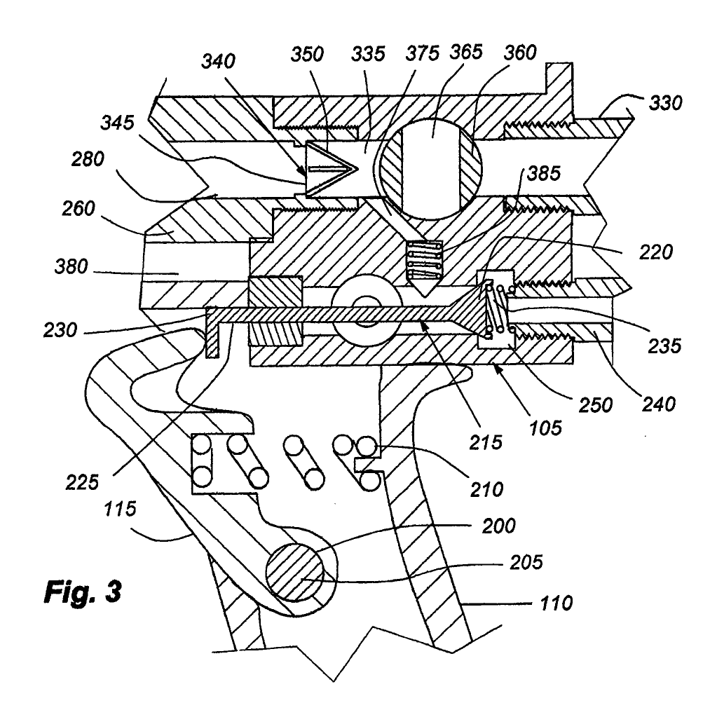

With reference to FIGS. 2 and 3 among other figures, the trigger 115 may be pivotally joined to the handle 110. More particularly, a lower portion of the trigger 115 may include a trigger aperture 200. A trigger axle 205 may be received through the trigger aperture 200. The trigger axle 205 may be joined to the handle 110. An upper portion of trigger 115 may be pivoted about the trigger axle 205, thus allowing the upper portion of the trigger 115 to move relative to the handle 110. A trigger biasing member 210, such as a coil spring, may be positioned between the trigger 115 and the handle 110 to bias the trigger to a first or rest position. The upper portion of the trigger 115 may be moved from the first position towards the handle 110 by pressing the trigger 115 towards the handle 110.

When the upper portion of the trigger 115 moves towards the handle 110, the upper portion may engage a clean agent valve 215. Such engagement may move the clean agent valve 215 from a closed position to an open position as the upper portion of the trigger 115 moves towards the handle 110. More particularly, the clean agent valve 215 may be a shuttle valve or any other suitable valve. The shuttle valve may include a valve portion 220, a valve shaft 225, and a valve flange 230. The valve portion 220 may be positioned at one end of the valve shaft 225, and the valve flange 230 may be positioned at the other end of the valve shaft 225.

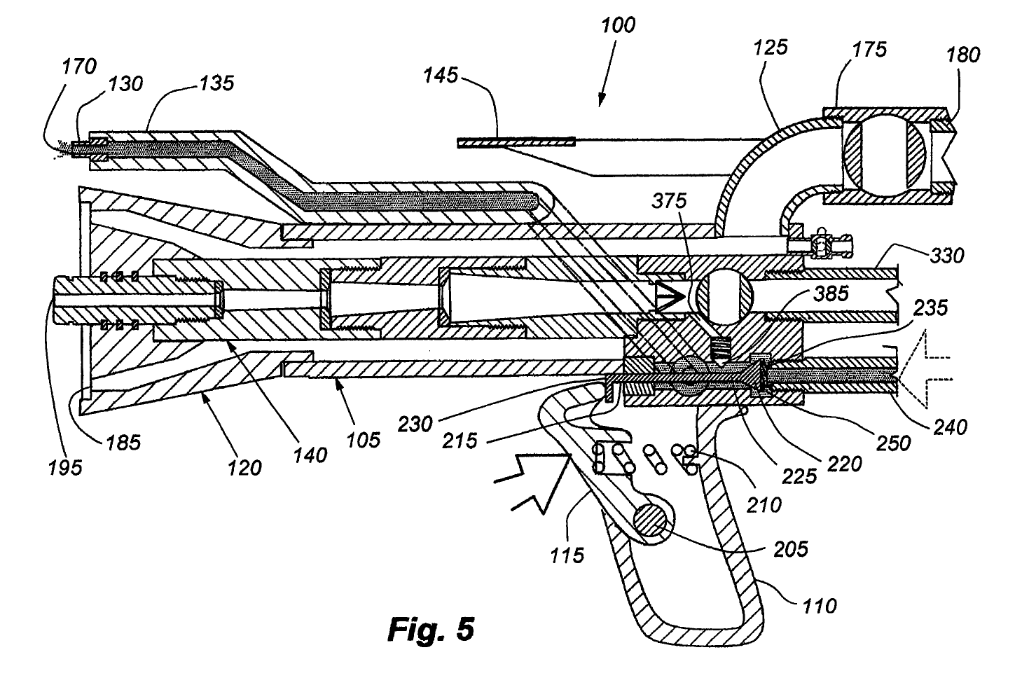

The clean agent valve 215 may be biased to a closed position by a clean agent biasing member 235, such as a coil spring. As the upper portion of the trigger 115 moves towards the handle 110 and engages the clean agent valve 215 via the valve flange 230, the trigger 115 moves the clean agent valve 215 from the closed position as shown in FIG. 2 to an open position as shown in FIG. 5. In this open position, clean agent, water or a combination thereof may flow from a clean agent source 160 and/or water source 165 to the clean agent nozzle 130 via a clean agent hose 240, a clean agent fluid passage 245, and the clean agent conduit 135.

The clean agent hose 240 may be threaded or otherwise suitably joined to the housing 105. The clean agent fluid passage 245 may be defined by the housing 105. The clean agent fluid passage 245 may include a valve chamber 250 for receiving the valve portion 220 of the clean agent valve 215. Engagement of the valve portion 220 of the clean agent valve 215 with a portion of the housing 105 defining the valve chamber 250 disables communication between the clean agent hose 240 and the clean agent conduit 135, thus preventing the flow of clean agent and/or water from the fire extinguishment apparatus 100. Disengagement of the valve portion 220 of the clean agent valve 215 with the housing 105 enables communication between the clean agent hose 240 and the clean agent conduit 135, thus selectively allowing the flow of clean agent and/or water from the fire extinguishment apparatus 100. The valve portion 220 may be disengaged from the housing 105 by moving the clean agent valve 215 relative to the housing 105 using the trigger 115 as described in more detail above.

The valve portion 220 may be re-engaged with the housing 105 by releasing or other ceasing to press the trigger 115 towards the handle 110. When the force moving the trigger 115 towards the handle 110 is removed, the trigger biasing member 210 returns the trigger 115 to its first position, thus removing the force that disengages the valve portion 220 of the clean agent valve 215 from the housing 105. Upon removal of this force, the clean agent biasing member 235 returns the clean agent valve 215 to the position where the valve portion 220 of the clean agent valve 215 engages the housing 105, thus disabling communication between the clean agent hose 240 and the clean agent conduit 135.

With continued reference to FIGS. 2 and 3, the dry chemical nozzle 140 may be a multiple stage dry chemical nozzle. The fire extinguishment nozzle assembly 100 may be configured so that a compensator 255 (see FIG. 24 for a schematic representation of the compensator 255) in combination with an inlet of the dry chemical nozzle 140 starts the process of delivering the dry chemical from the dry chemical nozzle in a consolidated stream. Further the dry chemical nozzle 140 may be configured to continue and/or enhance the consolidation process started by the combination of the compensator 255 and the inlet of the dry chemical nozzle 140. Such a configuration may also facilitate separation of the dry chemical from the high pressure air associated with it.

More particularly, the dry chemical nozzle 140 may take the form of a four stage system for delivering dry chemical in consolidated solid or semi-solid streams and for separating the dry chemical from its high pressure air, although more or less stages may be used. With reference to FIGS. 2, 3, 8 and 9, the four stage dry chemical nozzle 140 may be formed from four dry chemical nozzle segments, which for convenience will be referred to as first, second, third and fourth chamber segments 260, 265, 270, 275. Each segment may be joined to an adjacent segment using a threaded connection, such as shown for example in FIG. 2, or any other suitable connection method.

Returning to FIGS. 2 and 3, the first, second and third chamber segments 260, 265, 270 may each define a dry chemical passage or chamber 280, 285, 290 that tapers along at least a portion of the chamber segment radially inward from an outlet end to an inlet end for each respective chamber segment 260, 265, 270, and the fourth chamber segment 275 may define a dry chemical passage or chamber 295 with a substantially constant cross-section. The first chamber segment 260 (i.e., the chamber segment closest to the handle end of the fire extinguishment apparatus) may define a first dry chemical passage or chamber 280 that is generally larger in volume than the volume of a second dry chemical fluid passage or chamber 285 defined by the second chamber segment 265. Similarly, the volume of the second fluid passage or chamber 285 defined by the second chamber segment 265 may be greater than a volume of a third dry chemical fluid passage or chamber 290 defined by the third chamber segment 270. Likewise, the volume of the third fluid passage or chamber 290 defined by the third chamber segment 270 may be greater than a volume of a fourth dry chemical fluid passage or chamber 295 defined by the fourth chamber segment 275. Such an arrangement of the chamber segments 260, 265, 270, 275 facilitates the separation of the high pressure air from the dry chemical powder and concentrates the dry chemical powder into the central portion of the stream of material flowing through the chamber segments 260, 265, 270, 275.

First, second, and third collars 300, 305, 310 may be positioned at the outlet ends of the first, second and third chamber segments 260, 265, 270. More particularly, the first collar 300 may be positioned at the outlet end of the first chamber segment 260, the second collar 305 may be positioned at the outlet end of the second chamber segment 265, and the third collar 310 maybe positioned at the outlet end of the third chamber segment 270. Each collar 300, 305, 310 may define a collar aperture 315, 320, 325 to allow passage of the dry chemical between adjacent chamber segments 260, 265, 270, 275 to allow dry chemical to flow through the dry chemical nozzle 140. Collectively, the passages 280, 285, 290, 295 and apertures 315, 320, 325 defined by the chamber segments 260, 265, 270, 275 and the collars 300, 305, 310, respectively, define a dry chemical passage through the dry chemical nozzle 140.

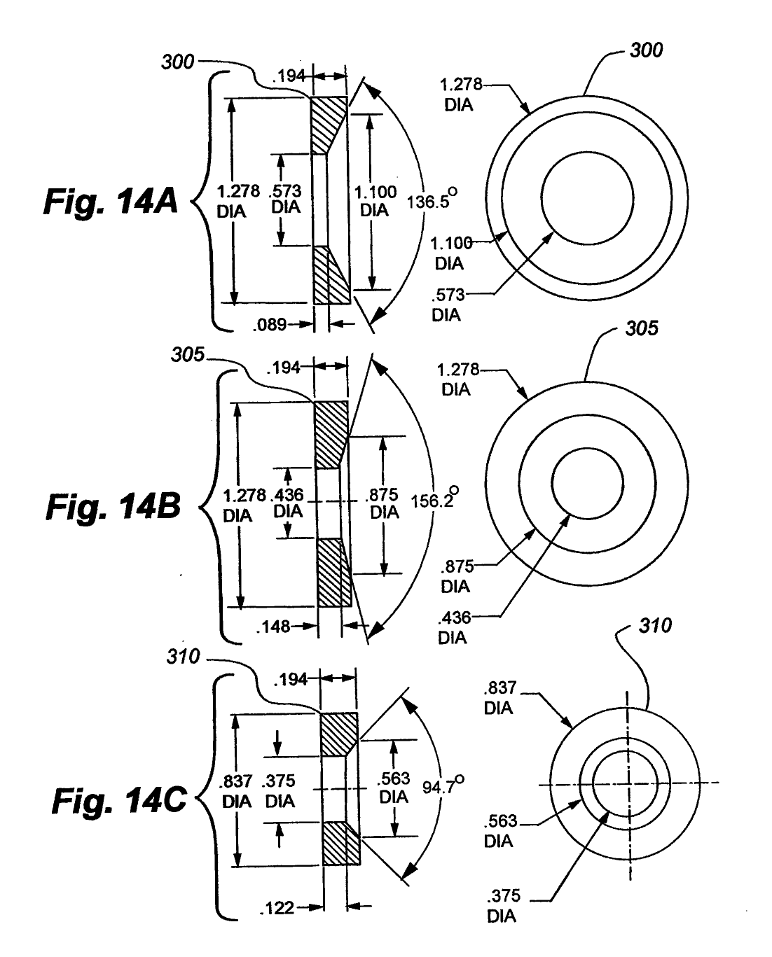

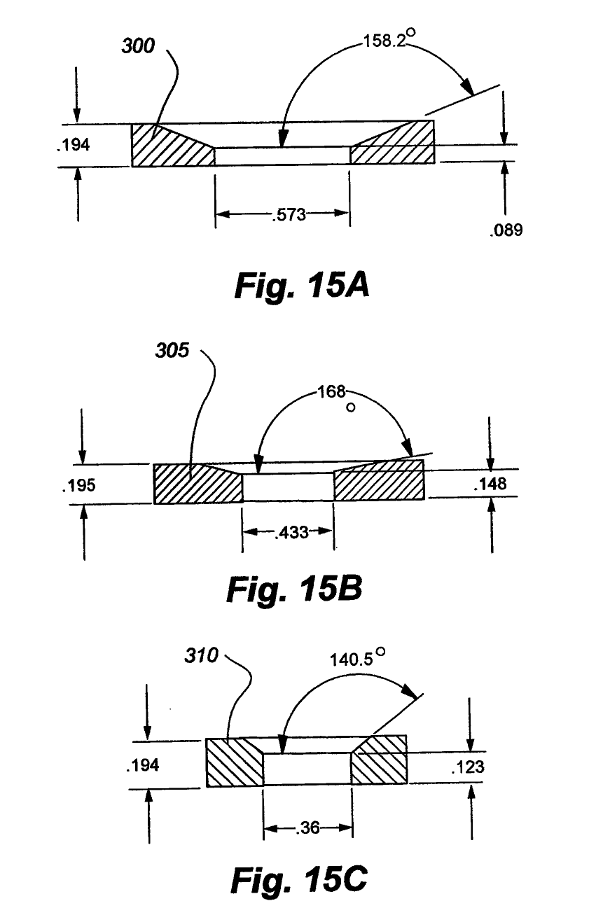

Each collar aperture 315, 320, 325 may be tapered radially inward from an inlet side (or surface) of each collar 300, 305, 310 towards an outlet side (or surface) of each collar 300, 305, 310. The taper may occur along a portion of the aperture 315, 320, 325 as shown, for example, in FIGS. 14 and 15, or may extend from the inlet side to the outlet side of the aperture 315, 320, 325. Although shown as linearly tapered inward, any collar aperture 315, 320, 325 may be concavely or convexly curved rather than linearly tapered to define a larger sized hole at the inlet side of the collar 300, 305, 310 and a smaller sized hole at the outlet side of the collar 300, 305, 310.

The minimum size of each collar aperture 315, 320, 325 at the outlet side of the collar 300, 305, 310 may vary for each collar 300, 305, 310. Further, the minimum size for the first collar aperture 315 may be greater than the minimum size of the second collar aperture 320, and the minimum size for the second collar aperture 320 may be greater than the minimum size of the third collar aperture 325. Such an arrangement in the size of the collar apertures 315, 320, 325 helps to concentrate dry chemical particulate to the center of the high velocity stream for discharge from the dry chemical nozzle 140. Yet further, the first, second and third chamber segments 260, 265, 270 and their respective collars 300, 305, 310 define a dry chemical passage that generally increases in cross-section from the inlet portion of a chamber segment 260, 265, 270 to the associated collar 300, 305, 310 and then decreases in cross-section from the inlet of the collar 300, 305, 310 to the outlet of the collar 300, 305, 310. Such a configuration helps to separate the dry chemical from the pressurized air stream and to compact the dry chemical into consolidated sections. Such an arrangement also facilitates the build up of dry chemical at the collars 300, 305, 310, which helps to stream the dry chemical in consolidated sections from the dry chemical nozzle.

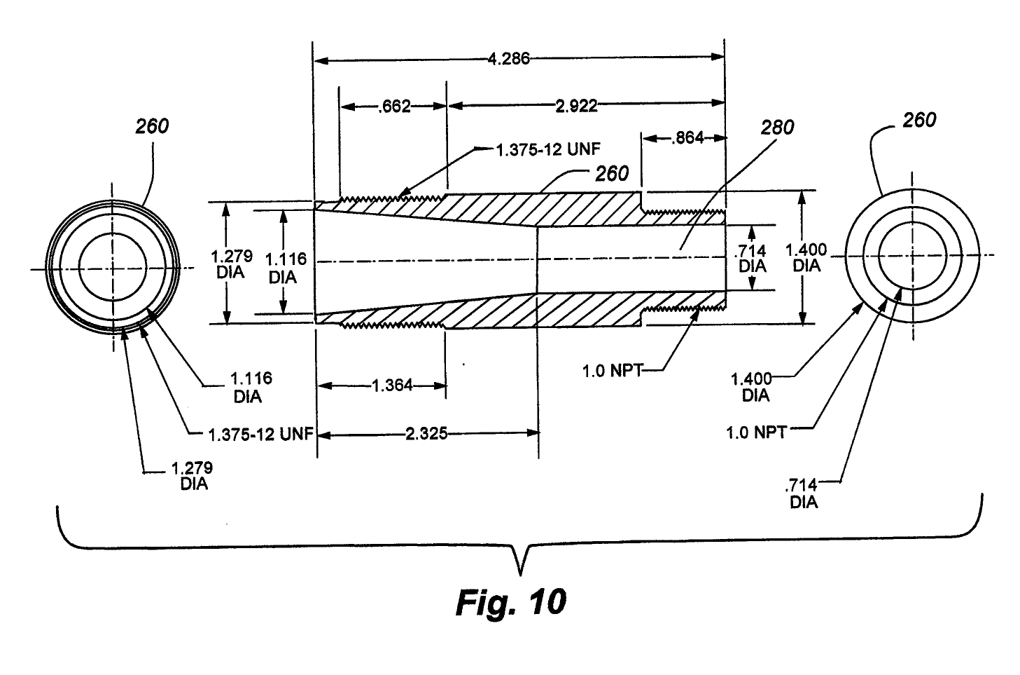

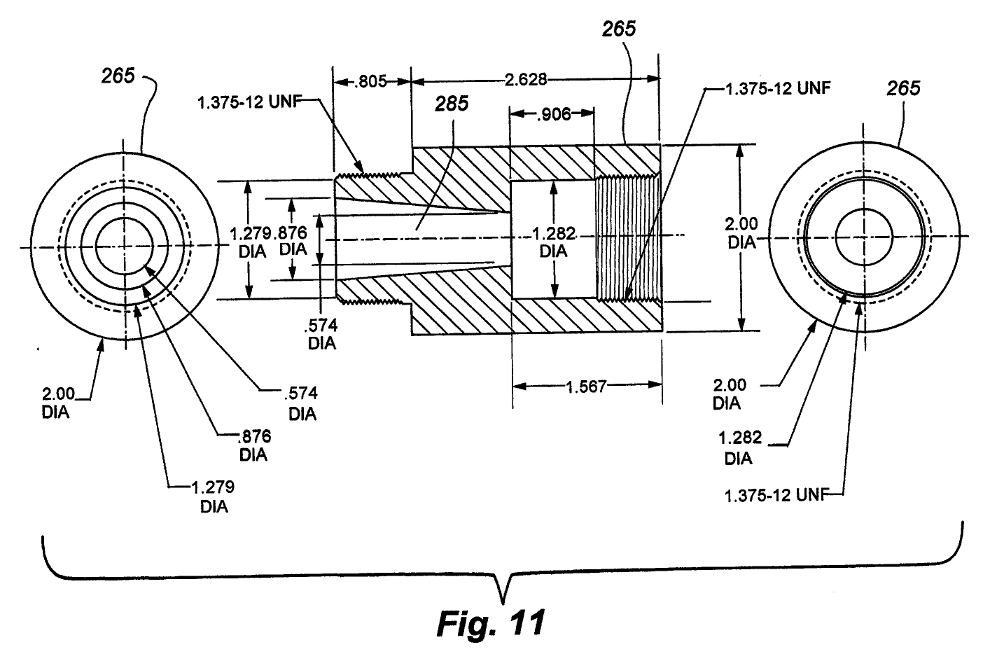

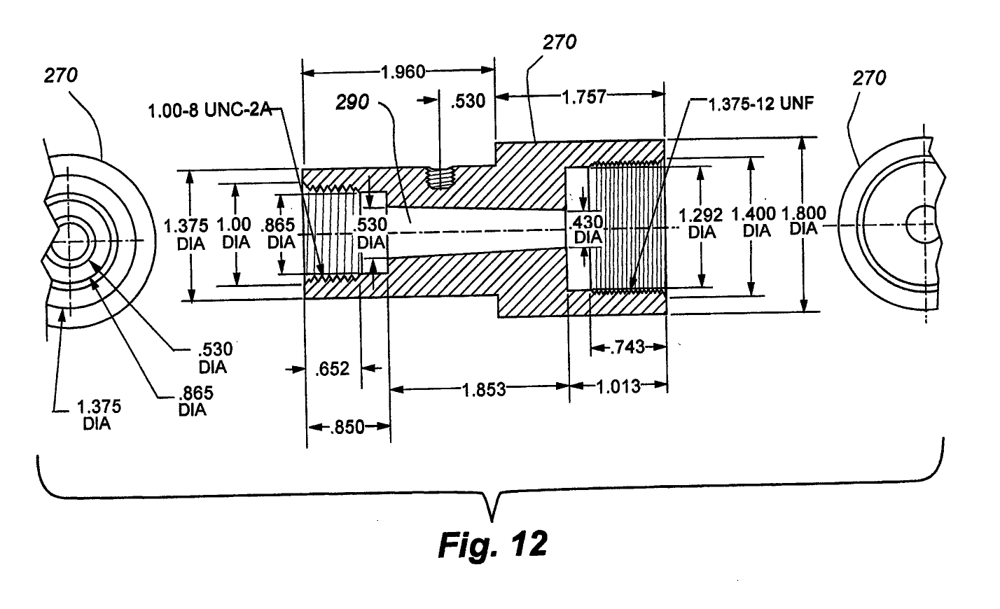

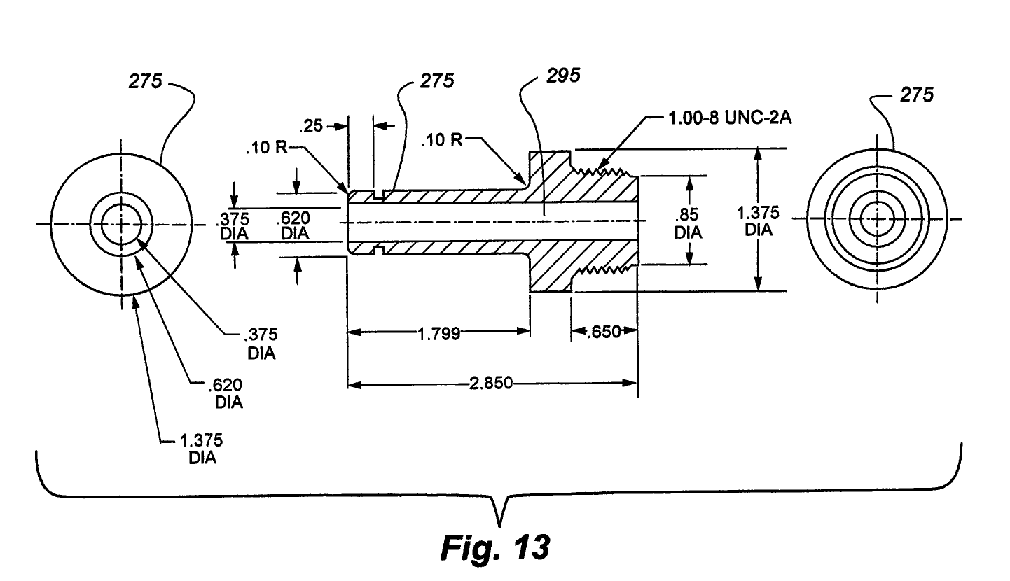

The chamber segments 260, 265, 270, 275 and collars 300, 305, 310 are sized and configured to create turbulence within the dry chemical fluid passage as the entrained dry chemical flows through the dry chemical passage, especially at pressures greater than 250 psi. This turbulent environment facilitates polarization of the dry chemical as it passes through the dry chemical nozzle 140. FIGS. 10-15 show representative dimensions in inches and degrees for the chamber segments 260, 265, 270, 275 and collars 300, 305, 310 to create a dry chemical nozzle 140 that can discharge a polarized dry chemical. For these dimensions of the chamber segments 260, 265, 270, 275, the volume of the first dry chemical chamber 260 may be approximately 1.55 cubic inches, the volume of the second dry chemical chamber 265 may be approximately 0.78 cubic inches, and the volume of the third dry chemical chamber 270 may be approximately 0.34 cubic inches. These dimensions and volumes may be used in a dry chemical nozzle 140 that can discharge dry chemical at a rate of 1 to more than 22 lbs/sec. A range of dimensions may be used for the chamber segments 260, 265, 270, 275 and collars 300, 305, 310 to allow such a flow rate. For example, FIGS. 14 and 15 show some possible dimensions for the collars 300, 305, 310. These dimensions are merely representative as the dry chemical nozzle 140 is scaleable. Further, other dimensions may be used for the chambers and collars to achieve substantial polarization of the dry chemical.

To discharge greater or lesser volumes of dry chemical per second in a concentrated manner, the dry chemical nozzle 140 may be scaled up or down, respectively, by proportionately increasing (for scaling up) or decreasing (for scaling down) the minimum collar apertures 315, 320, 325, the volumes of the dry chemical passages 280, 285, 290, 295 defined by the chamber segments 260, 265, 270, 275, and the lengths of the dry chemical fluid passages 280, 285, 290, 295 defined by the chamber segments 260, 265, 270, 275. For example, to increase the volume of dry chemical discharged, the minimum collar apertures 315, 320, 325, the volumes of the dry chemical passages 280, 285, 290, 295, and the lengths of the dry chemical passages 280, 285, 290, 295 may each be scaled up by the same factor (e.g., the ratio of the minimum collar aperture 315, 320, 325 to the volume of its respective dry chemical passage 280, 285, 290 remains the same, and the ratio of the volume of a dry chemical passage 280, 285, 290, 295 to its length remains the same).

Each collar 300, 305, 310 may be composed of stainless steel, and each chamber segment 260, 265, 270, 275 may be composed of aluminum. However, the collars 300, 305, 310 and chamber segments 260, 265, 270, 275 may be composed of any material that allows for the free flow of dry powder or clean agents, including, but not limited to, ceramics or hard plastics. As the dry chemical flows at a high speed through a dry chemical hose 330 and the various chamber segments 260, 265, 270, 275 and collars 300, 305, 310, the turbulence creates friction and/or heat between the dry chemical and the dry chemical hose 330, collars 300, 305, 310 and/or the chamber segments 260, 265, 270, 275 that polarizes the dry chemical particles. This polarization may be used to create sub atomic and atomic level polarity attraction between the dry chemical and a fire being extinguished using the dry chemical.

For example, the dry chemical may be electrostatically charged as it flows through the dry chemical nozzle 140 and the dry chemical hose 330 in order to be electrically attracted to positively charged plasma of a fire, or the negative anionic and free radical components of the fire which are generally associated with a fire's ability to propagate. The amount of polarization may be a function of one or more of the following: flow velocity, length of the hose 330, type of material forming the hose 330, type of materials forming the chamber segments 260, 265, 270, 275 and collars 300, 305, 310, the induced turbulence resulting from the configuration of the chamber segments 260, 265, 270, 275 and collars 300, 305, 310, and the type of materials flowing in the system. In some embodiments, an electrical source operatively associated with the dry chemical nozzle 140 may be used to polarize the dry chemical. Such electrical sources may include, but are not limited to, capacitors, static generators, batteries or the like electrically connected to the dry chemical nozzle 140 at the inlet, outlet, or any other suitable location within the dry chemical nozzle 140. Although the chamber segments 260, 265, 270, 275 are described as composed of aluminum and the collars 300, 305, 310 as composed of stainless steel, the chamber segments 260, 265, 270, 275 and collars 300, 305, 310 may be composed of other materials, including, but not limited to, ceramics and plastics that may polarize the dry chemical.

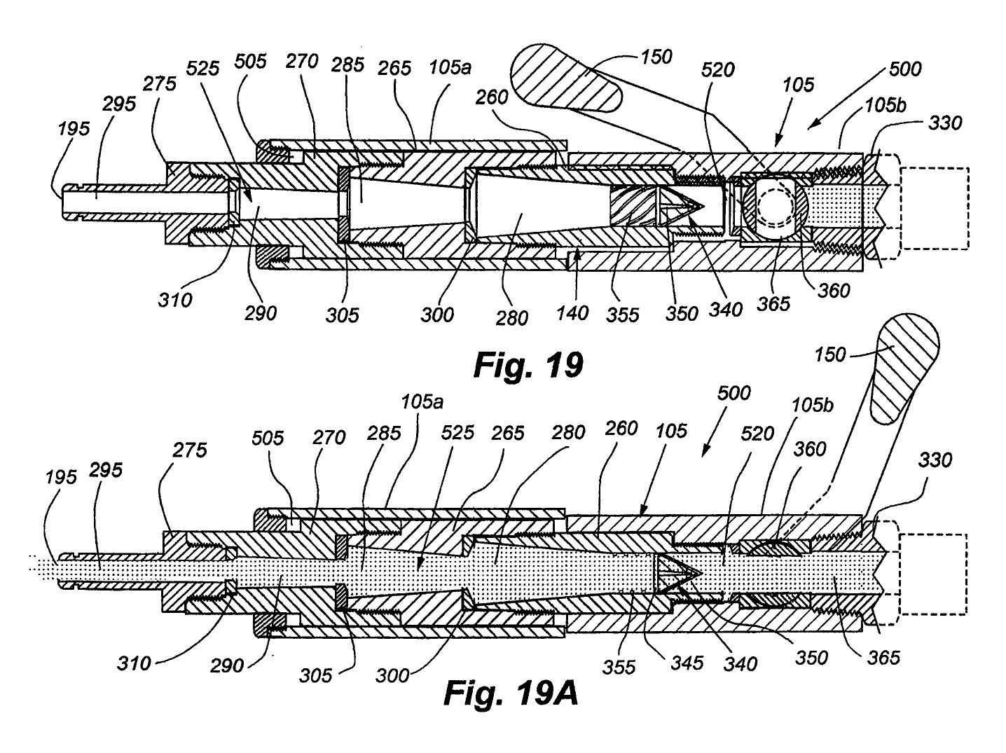

The inlet end of the first chamber segment 260 may be joined by a threaded or other suitable connection to the housing 105 proximate an outlet end of a housing dry chemical passage 335 defined by the housing 105. A disrupter, deflector or other suitable structure 340 may be positioned proximate the outlet end of the housing dry chemical passage 335 to facilitate the creation of turbulence within the dry chemical nozzle 140 by creating a disruption in the flow characteristics of the dry chemical. This also reinforces the separation of high pressure air from the dry chemical. The disruptor 340 may deflect dry chemical towards the internal surface of the first chamber segment 260 defining the first dry chemical passage or chamber 280 and/or may cause the dry chemical to rotate in a pre-determined direction (e.g., either in a clockwise or a counterclockwise direction). The disruptor 340 may include an annular or other suitable shaped disruptor base 345 with two or more disrupter vanes 350 extending away from distinct radial portions of the disruptor base 345 towards a common point or apex. There may be a multi-groove rifling section 355 at the inlet section of the first chamber segment 260 in a clockwise or counterclockwise direction after the core deflector or disrupter 340 (see, e.g., FIG. 19) to facilitate separation of the dry chemical from the high pressure air. After the first rifled section 355, there may be a second rifled grooved section directing the dry chemical in the opposite direction from the first rifled section 355 for further deflection of the flow of the dry chemical to further enhance separation of the dry chemical from the high pressure air flow.

With reference to FIGS. 2 and 3, the fourth chamber segment 275 may define the fourth dry chemical passage 295 that extends from the inlet end to the outlet end of the fourth chamber segment 275. The dry chemical outlet 195 for allowing dry chemical to exit the fire extinguishment apparatus 100 may be defined in the fourth chamber segment 275 at the outlet end of the fourth chamber segment 275.

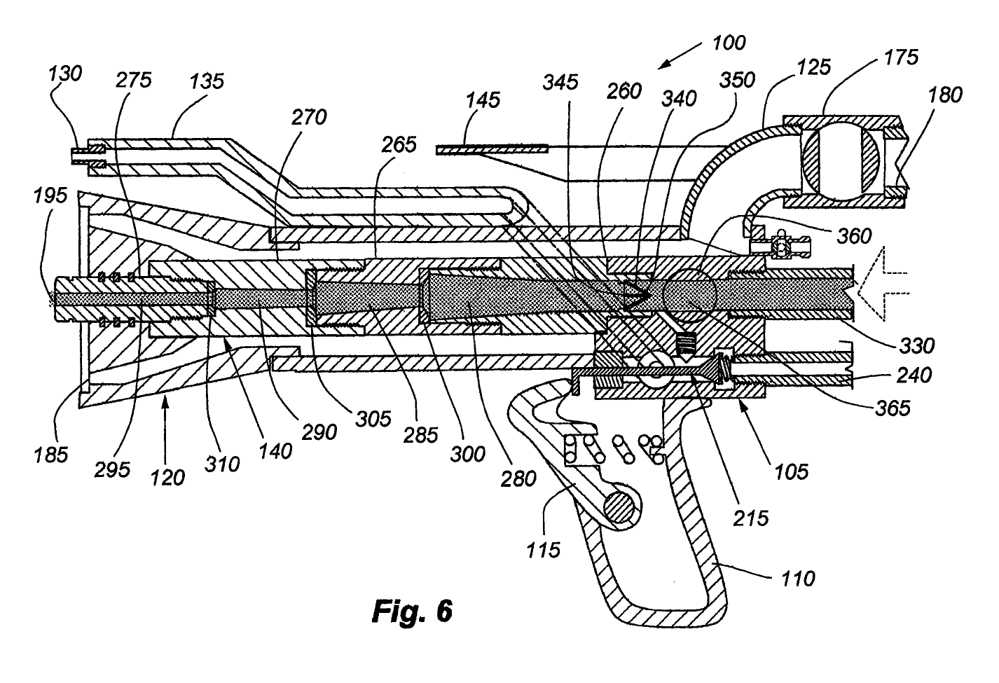

The dry chemical hose 330 may be joined to the housing 105 by a threaded or other suitable connection proximate an inlet end of the housing dry chemical passage 335. A dry chemical valve 360 may be positioned within the housing dry chemical passage 335 to selectively enable and disable communication between the dry chemical nozzle 140 and the dry chemical hose 330. More particularly, the dry chemical valve 360 may be a ball valve or any other suitable valve. The dry chemical valve 360 may be selectively rotated relative to the housing 105 using the dry chemical handle 150, and may define a dry chemical valve passage 365. When the dry chemical valve passage 365 does not at least partially align with the housing dry chemical passage 335 as shown, for example, in FIG. 2, communication between the dry chemical hose 330 and the dry chemical passage of the dry chemical nozzle 140 is disabled. When the dry chemical valve passage 365 at least partially aligns with the housing dry chemical passage 335 as shown, for example, in FIG. 6, communication between the dry chemical hose 330 and the dry chemical passage of the dry chemical nozzle 140 is enabled. A partial opening of the dry chemical valve 360 will allow the dry chemical to flow from the dry chemical nozzle 140 at a restricted rate of discharge.

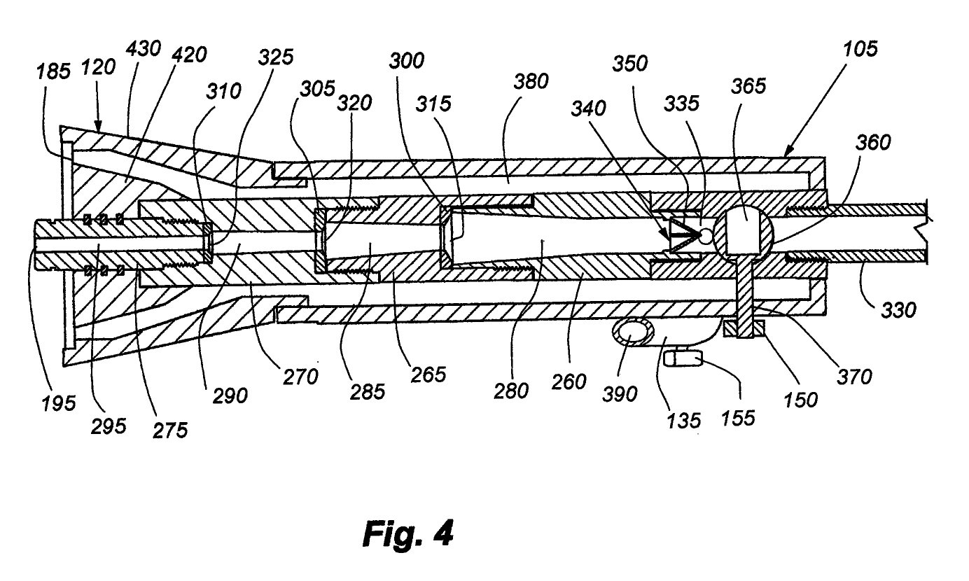

The dry chemical valve 360 may be selectively rotated relative to the housing 105 with the dry chemical handle 150. More particularly, the dry chemical handle 150 may be operatively joined to the dry chemical valve 360 by a dry chemical handle axle 370 (see FIG. 4) that extends between a lower portion of the dry chemical handle 150 and the dry chemical valve 360. Selective rotation of the dry chemical handle 150 around an axis defined by the dry chemical axle 370 rotates the dry chemical valve 360 around this same axis. As the dry chemical valve 360 rotates around the axis defined by the dry chemical handle axle 370, the dry chemical valve 360 rotates relative to the housing 105, thus changing the relative alignment of the valve dry chemical passage 365 and the housing dry chemical passage 335.

While the dry chemical nozzle 140 has been described with particularly, the fire extinguishment nozzle system 100 could utilize other types of dry chemical nozzles. For example, the dry chemical nozzle described in U.S. Pat. No. 5,344,077, which is hereby incorporated herein by reference in its entirety, could be utilized with the fire extinguishment nozzle system 100 to deliver slugs of dry chemical from the fire extinguishment nozzle system 100. The foregoing example is merely illustrative and is not intended to limit other types of dry chemical nozzles that may be used in the fire extinguishment nozzle system 100.

With continued reference to FIGS. 2 and 3 and other figures, the housing 105 may further define a clean agent-dry chemical passage 375 that extends from the clean agent passage 245 to the housing dry chemical passage 335 to allow delivery of clean agent to the dry chemical nozzle 140. The clean agent-dry chemical passage 375 allows the clean agent to flow from the clean agent passage 245 to the housing dry chemical passage 335. From the housing dry chemical passage 335, the clean agent may flow from the dry chemical outlet 195 via the dry chemical passage defined by the dry chemical nozzle 140. The clean agent may be mixed with the dry chemical in the housing dry chemical passage 335 when the dry chemical is flowed through the dry chemical nozzle 140.

The housing may further define a clean agent-water passage that extends from the clean agent passage to a fluid passage or chamber 380 defined by the housing 105. This clean agent-water passage may be inserted to allow delivery of an agent, such as clean agent, to the water nozzle 120. The type of agent may be any suitable agent, including, but not limited to, clean agent, high pressure air for the creation of “Super CAF”, high pressure or ultra pressure water, foam, or a foam/water combination.

A clean agent-dry chemical valve 385 may be positioned within the clean agent-dry chemical passage 375. The clean agent-dry chemical valve 385 may be a check valve or other one way valve that allows flow of material, such as the clean agent, from the clean agent passage 245 to the housing dry chemical passage 335 but prevents flow of material in the opposite direction. The clean agent valve 385 may be configured such that the clean agent-dry chemical valve 385 opens independently or by manual triggering when dry chemical flows through the dry chemical nozzle 140 and closes when dry chemical is not flowing through the dry chemical nozzle 140. A similar one-way valve may be positioned within the clean agent-water passage to allow flow of material to the water passage 380 from the clean agent passage 245 while preventing flow of material in the opposite direction.

The switch 155 may be joined to a valve, such as a ball valve or the like. The switch 155 may be rotatably or otherwise movable joined to the clean agent conduit 135 to selectively allow fluid communication between the clean agent hose 240 and the clean agent nozzle 130 to be enabled and disabled. Communication may be enabled by rotating the switch 155 to a position where a fluid passage defined by the ball or other valve of the switch 155 aligns with the clean agent fluid passage 245 and a clean agent conduit passage 390 defined by the clean agent conduit 135 and disabled by rotating the switch to a positioned where the passage does not align with these passages 245, 390. When enabled, clean agent and/or water may flow through the clean agent nozzle 130 when the trigger 115 is pressed to open the clean agent valve 215. Further, when enabled, the clean agent-dry chemical valve remains closed to prevent flow of clean agent to the dry chemical nozzle 140. When disabled, the clean agent may be diverted to the dry chemical nozzle 140 through the clean agent-dry chemical passage 375 for mixing with the dry chemical (or for independently being emitted from the dry chemical nozzle 140) when the trigger 115 is pressed to open the clean agent valve 215. More particularly, build up of the clean agent in the clean agent passage 245 creates a sufficient pressure to overcome the biasing or other force closing the clean agent-dry chemical valve 385, thus allowing clean agent to flow into the clean agent-dry chemical passage 375. The switch 155 may further include a no flow position that prevents the clean agent from flowing to either the clean agent nozzle 130 or the dry chemical nozzle 140 even when the trigger is activated. The switch 155 may also be used to inject other types of agents into the clean agent nozzle 130, the dry chemical nozzle 140, or the water nozzle 120 by joining such an agent to the clean agent hose 240.

With continued reference to FIG. 2 among other figures, the water conduit 125 may define a water conduit passage 395 in fluid communication with the fluid chamber or passage 380 defined by the housing 105 and the dry chemical nozzle 140. The defined fluid chamber 380 may generally encompass the dry chemical nozzle 140. The fluid chamber 380, in turn, may be in fluid communication with a nozzle chamber or fluid passage 400 defined by the water nozzle 120. A water/air injection port 405 may be defined in the housing 150 proximate the water conduit 125 to extend from the fluid chamber 380 to an exterior surface of the housing 150. A pressured air source or pressurized water source may be operatively associated with the water/air injection port 405 to allow for pressurized air or pressurized water to be supplied to the fluid chamber 380. A water/air injection valve 410 may be positioned in the water/air injection port 405. The water/air injection valve 410 may be configured to an opened position when pressurized air or water is provided to the fluid chamber 380 from the pressurized air source, pressurized water source or the like and to a closed position when pressurized air or pressurized water is not being provided to the fluid chamber 380. Pressurized air/water may be used to convert the water or water/foam into a pressurized (e.g., 125-250 psi), a high pressurized (250-600 psi), or an ultra high pressurized (>600 psi) water stream. Ultra pressurizing the water may be used to deliver the water from the fire extinguishment nozzle assembly 100 as a high pressure mist, fog, or as extremely fine droplets, which can more rapidly absorb heat from the fire.

The water nozzle 120 may include one or more fluid outlets 185. The fluid outlets 185 may be arranged to encompass the dry chemical outlet 195. However, the fluid outlets 185 may be configured to extend around only a portion, or portions, of the dry chemical outlet 195. For example, fluid outlets 185 may be configured along a lower half portion of the water nozzle 120 (e.g., around about the lower 50 percent of a water nozzle face 415) with the dry chemical outlet 195 positioned within a central portion of the water nozzle face 415, and the outlet 170 for the clean agent nozzle 130 positioned within the upper portion of the water nozzle face 415 (i.e., above the dry chemical outlet 195). Further, deflectors or other suitable structures may be positioned proximate the fluid outlet or outlets 185 to cause a least a portion of the fluid to converge towards and/or mix with dry chemical that exits the dry chemical nozzle 140. Yet further, a ring or other structure having stops or deflectors may be joined to the water nozzle 120 to deflect or block a predefined percentage (e.g., 10% or more) of water flow from the fluid outlets 185. Still yet further, the water nozzle 120 may include only a single outlet to form a side-by-side (or parallel) liquid stream, clean agent and/or water stream and dry powder flow.

The water nozzle 120 may include a nozzle core portion 420 for joining the water nozzle 120 to the dry chemical nozzle 140. The nozzle core portion 420 may be joined to the dry chemical nozzle 140 by press fit or any other suitable connection. The water nozzle 120 may further include an outer nozzle wall 430, which encompasses the nozzle core portion 420 for joining the water nozzle 120 to the housing 105. The nozzle wall 430 may be joined to the housing 105 by press fit or any other suitable connection. The nozzle core portion 420 and the nozzle wall 430 may define the nozzle chamber 400.

The water hose 180 may be joined to the water conduit connector 175 by a threaded connection or any other suitable connection. The water conduit connector 175 may include a water valve 435 to selectively enable and disable fluid communication between the water hose 180 and the water nozzle 120. The water valve 435 may be a ball valve or any other suitable valve. The water valve 435 may define a water valve passage 440 that may be selectively aligned with a hose fluid passage 445 defined by the fluid hose 180 and a water conduit passage 395 defined by the water conduit 125 to selectively enable fluid communication between the fluid hose 180 and the water nozzle 120. The water valve passage 440 may be selectively aligned with these passages 395, 445 (i.e., opened) by selectively rotating the water valve 435 relative to the water conduit connector 175 using the water handle 145.

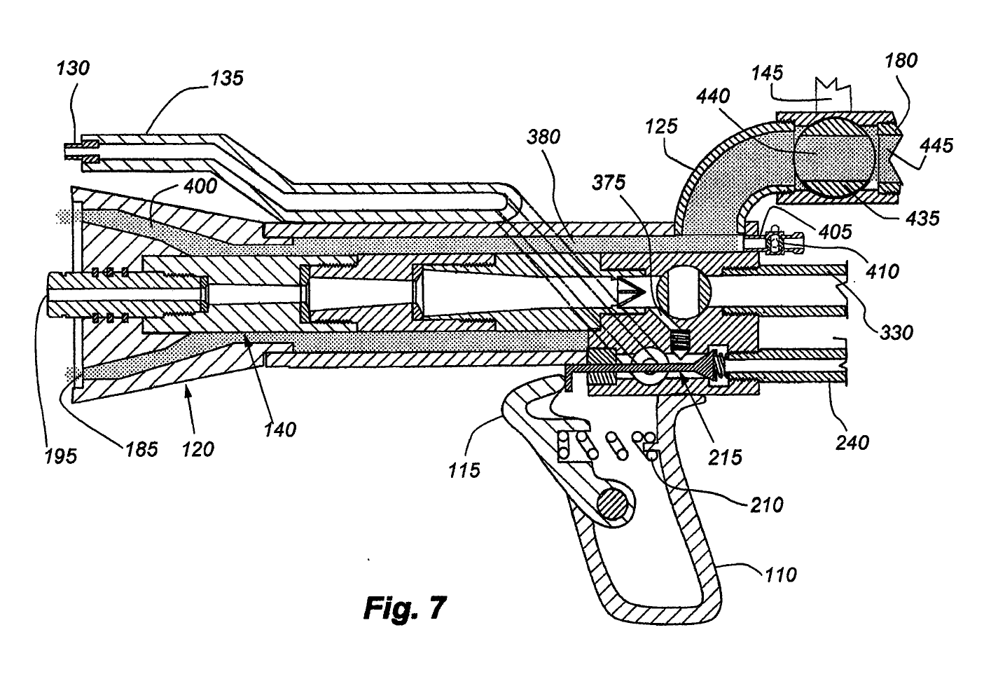

More particularly, the water handle 145 may include water handle axle that joins the water handle 145 to the water valve 435. The water handle 145 may be rotated around an axis defined by the water handle axle. Rotation of the water handle 145 around this axis rotates the water valve 435 around this axis. As the water valve 435 rotates around this axis, the water valve 435 rotates relative to the water conduit connector 175. Rotation of the water valve 435 moves the water valve passage 440 from a non-aligned to an aligned position with the hose fluid passage 445 and the water conduit passage 395. When in a non-aligned position as shown in FIG. 2, fluid communication between the water nozzle 120 and the fluid hose 180 is disabled. When in at least a partially aligned position as shown, for example, in FIG. 7, fluid communication between the fluid hose 180 and the water nozzle 120 is enabled. A partial opening of the water valve 435 allows the water or water/foam to flow from the water nozzle 120 at a restricted rate of discharge.

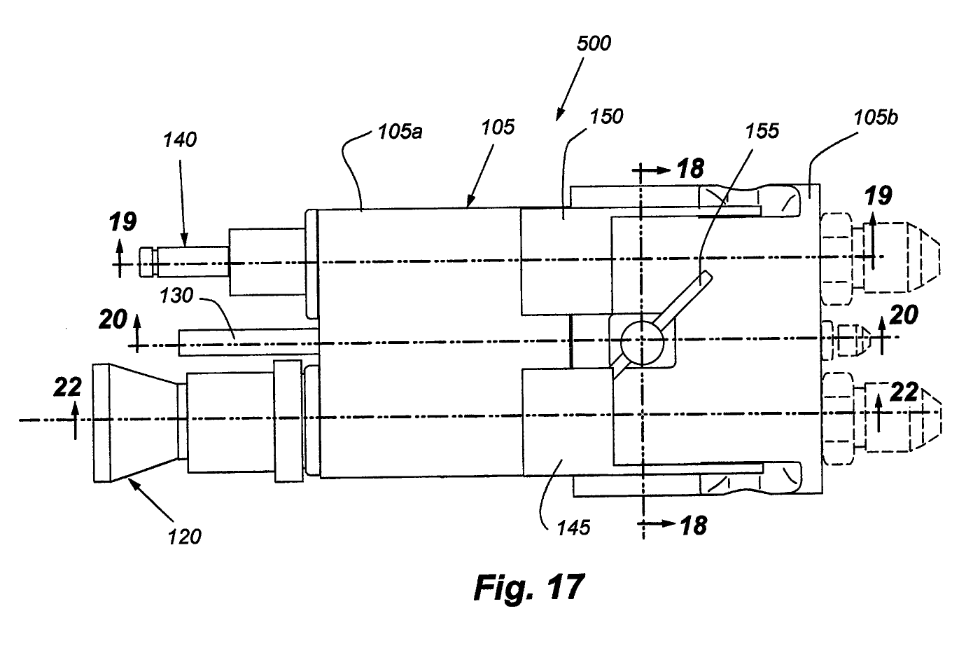

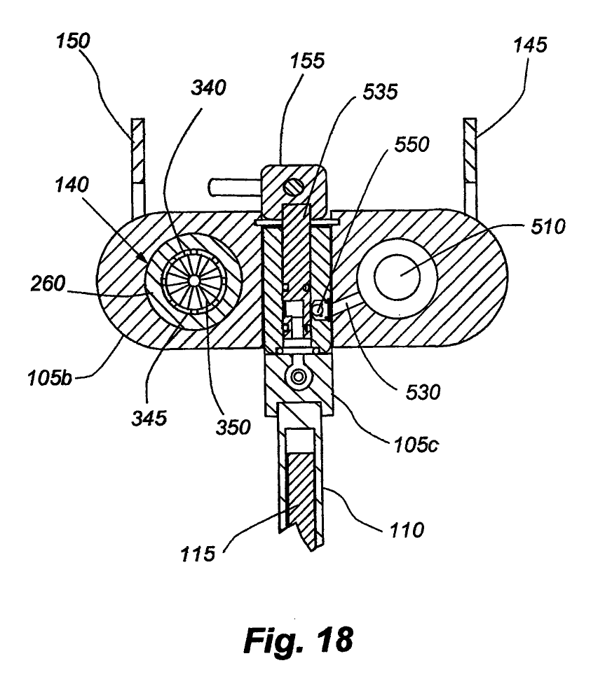

FIGS. 16-23 depict various views of a second example of a fire extinguishment apparatus 500, which may also be referred to as a fire extinguishment nozzle assembly or a fire extinguishment nozzle system. In many aspects, the second fire extinguishment apparatus 500 is the same as the first fire extinguishment apparatus 100, and generally the same reference numbers will be used for components of the second fire extinguishment apparatus 500 that are similar to, or the same as, components shown and described above with respect to first fire extinguishment apparatus 100. Some primary differences between the first fire extinguishment apparatus 100 and second fire extinguishment apparatus 500 are the dry chemical nozzle 140 is not positioned within the water nozzle 120 and the clean agent nozzle 130 is positioned between the dry chemical nozzle 140 and the water nozzle 120. Instead of positioning the dry chemical nozzle 140 within the water nozzle 120, the dry chemical nozzle 140 is positioned parallel to, and offset from, the water nozzle 120. Such positioning allows for emission from the first extinguishment apparatus of streams of water, high pressure water, foam, or water/foam that are parallel to dry chemical and clean agent streams.

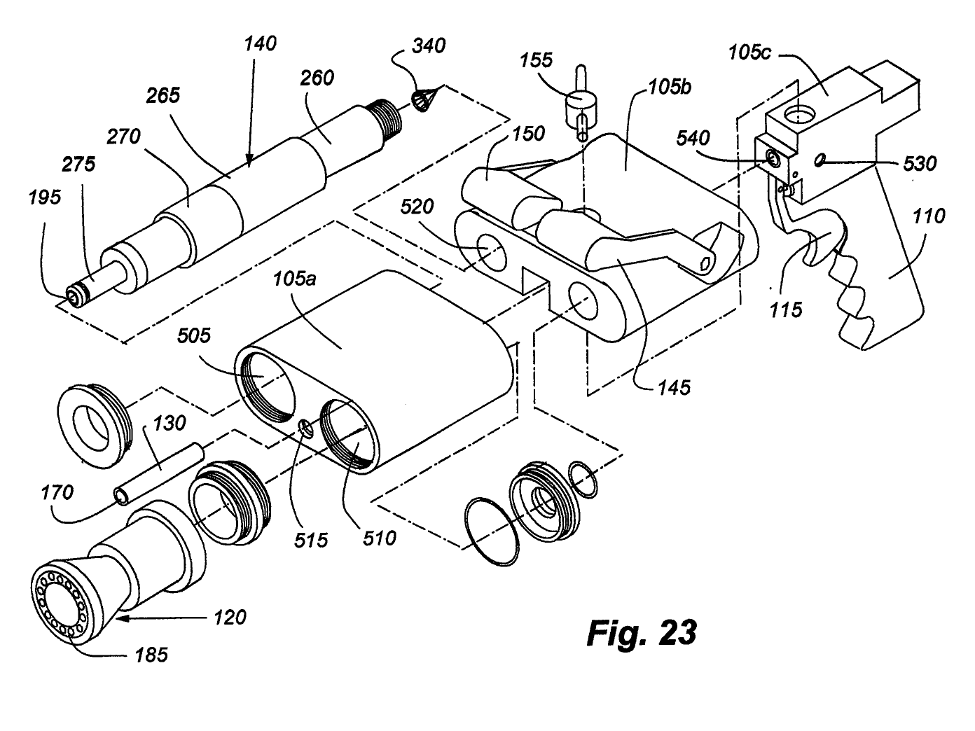

Like the first fire extinguishment apparatus 100, the second fire extinguishment apparatus 500 may include a housing 105, a handle 110, a trigger 115, a water nozzle 120, a clean agent nozzle 130, a dry chemical nozzle 140, a water handle 145, a dry chemical handle 150, and a switch 155. The housing 105 may be a generally elongated ellipsoid or any other suitable shape that provides a structure for supporting the water, dry chemical and clean agent nozzles 120, 140, 130. The housing 105 may be formed from one or more housing bodies 105a-c. When formed from two or more housing bodies 105a-c, the various bodies may be joined using any suitable connection methods, including, but not limited to, welding, mechanical fasteners and so on. With reference to FIG. 23 and other figures, the housing 105 may define a passage 505 or the like for receiving the dry chemical nozzle 140. The housing 105 may also define passages 510, 515, 520 for fluidly connecting the water, clean agent, and dry chemical nozzles 120, 130, 140 joined to the housing 105 with water (or foam or water/foam), clean agent, and dry chemical hoses also joined to the housing 105.

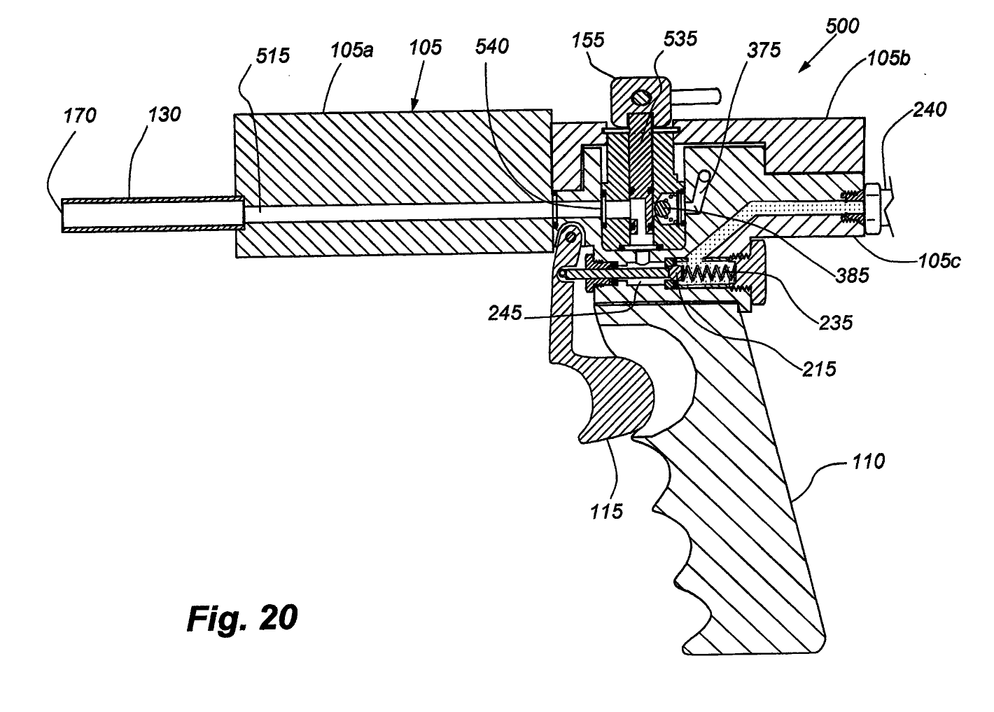

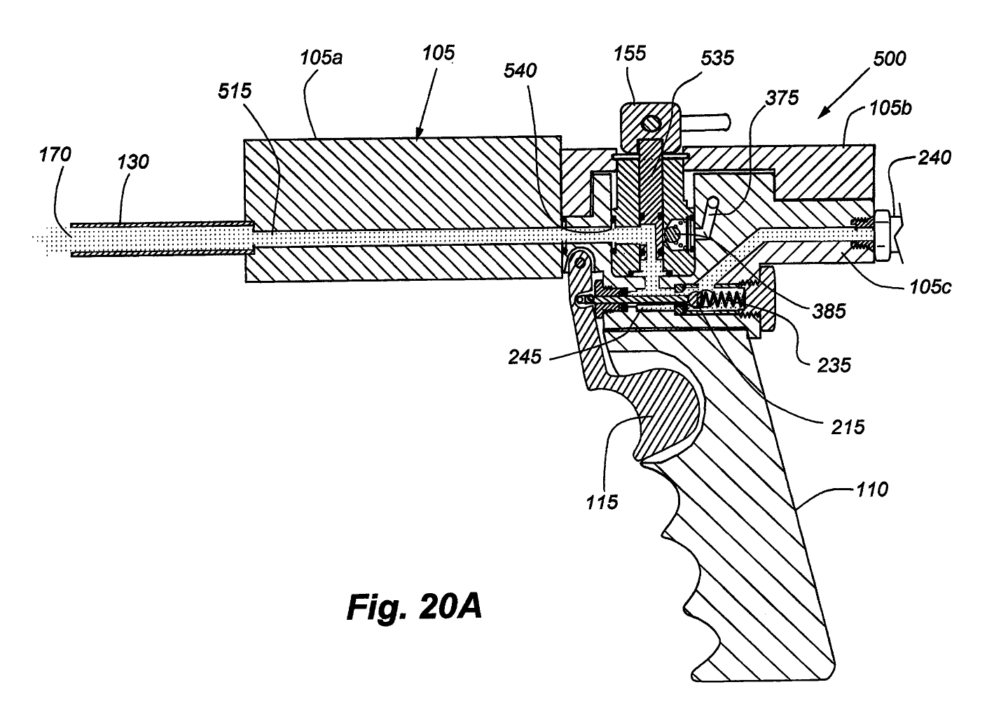

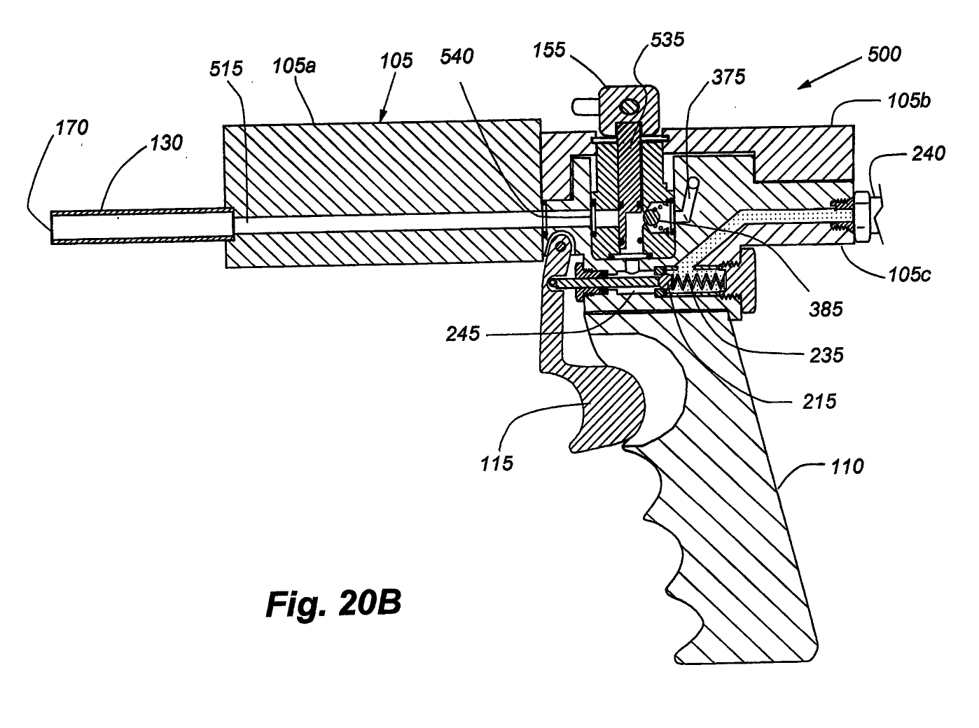

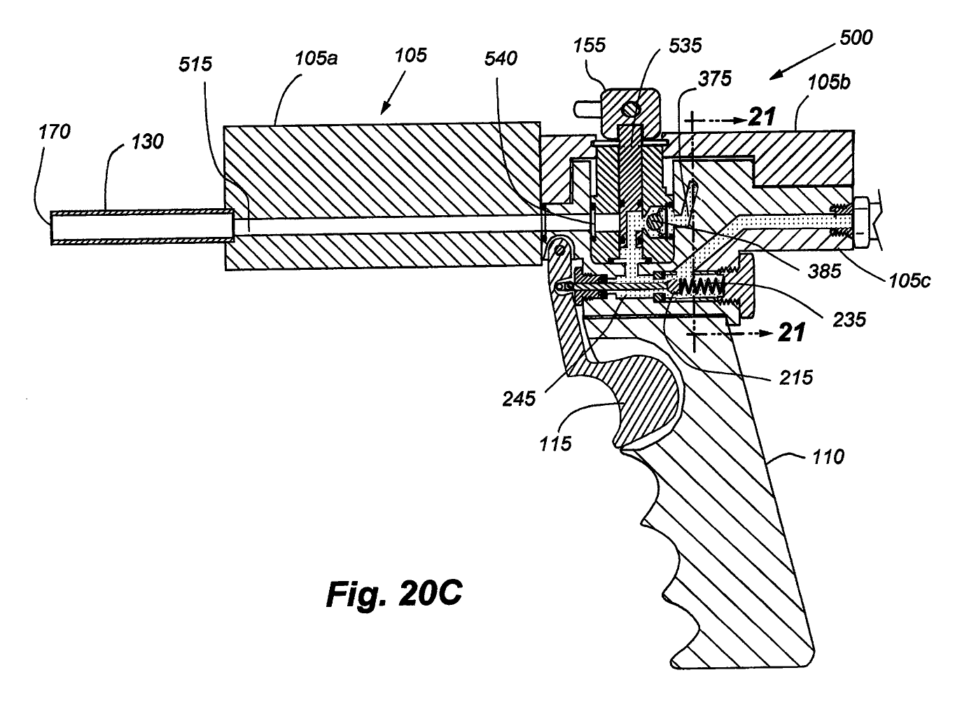

Like the first fire extinguishment apparatus 100, the handle 110 for the second fire extinguishment apparatus 500 may extend downwardly from a lower portion of the housing 105 and may be integrally formed with the housing 105 or joined by a suitable connection method. The handle 110 may be sized to be grasped by a user's hand and may include a contoured surface that defines grooves or the like for receiving a user's fingers. Like the first fire extinguishment apparatus 100, the trigger 115 for the second fire extinguishment apparatus 500 may be movably joined to the handle 110 as shown, for example, in FIGS. 20-20C. As described in more detail above with respect to the first fire extinguishment apparatus 100, the trigger 115 may be used to control the flow of a chemical agent, such as halon. In general, the trigger 115 for the second fire extinguishment apparatus 500 is similar to the trigger 115 for the first fire extinguishment apparatus 100 expect it utilizes a ball and a spring as the valve and bias member 215, 235, respectively, to selectively enable and disable clean agent flow to the clean agent or dry chemical nozzles 130, 140 as shown, for example, in FIGS. 20-20C. However, while the bias member 235 and valve 215 are shown as a spring and a ball, any suitable valve and bias system may be used.

The dry chemical 150 handle for the second fire extinguishment apparatus 500 be movably joined to its housing 105 in a manner similar to the dry chemical handle 150 for the first fire extinguishment apparatus 100. As described in more detail above with respect to the first fire extinguishment apparatus 100, selective movement of the dry chemical handle 150 of the second fire extinguishment apparatus 500 relative to the housing 105 enables and disables communication between a dry chemical source 190 (or other chemical or water source) and the dry chemical nozzle 140, thus allowing and preventing flow of material through the nozzle 140 as shown, for example, in FIGS. 19 and 19A. As with the first fire extinguishment apparatus 100, when such communication is enabled, dry chemical exits the second fire extinguishment apparatus 500 via a dry chemical outlet 195 defined by the dry chemical nozzle 140, as shown, for example, in FIG. 19A. Like the first fire extinguishment apparatus 100, the dry chemical outlet 195 (or outlets) for the second fire extinguishment apparatus 500 may be circular or any other suitable shape.

With continued reference to FIGS. 19 and 19A, the dry chemical nozzle 140 for the second fire extinguishment apparatus 500 may be a multiple stage dry chemical nozzle like the dry chemical nozzle 140 for the first fire extinguishment apparatus 500. As described in more detail above with respect to the first fire extinguishment apparatus 100, the second fire extinguishment apparatus 500 may be configured so that a compensator 255 in combination with the dry chemical nozzle 140 starts the process of delivering the dry chemical from the dry chemical nozzle 140 in consolidated sections. Further, as described in more detail above with respect to the first fire extinguishment apparatus 100, the dry chemical nozzle 140 of the second fire extinguishment apparatus 500 may be configured to separate the dry chemical from the high pressure air associated with it. Still yet further, as described in more detail above with respect to the first fire extinguishment apparatus 100, the dry chemical nozzle 140 for the second fire extinguishment apparatus 500 may be configured such that dry chemical exiting the dry chemical nozzle 140 is substantially polarized. Like the first extinguishment apparatus 100, the dry chemical nozzle 140 for the second fire extinguishment apparatus 500 could utilize other types of dry chemical nozzles.

The second fire extinguishment apparatus 500 may include a disruptor, deflector or other suitable structure 340 positioned in or proximate the dry chemical nozzle 140. As described above with respect to the first fire extinguishment apparatus 100, the disruptor 340 facilitates the creation of turbulence by creating a disruption in the flow characteristics of the dry chemical, which reinforces the separation of high pressure air from the dry chemical. As with the first fire extinguishment apparatus 100, there may be a multi-groove rifling section 355 at the inlet section of the first chamber segment 260 of the second fire extinguishment apparatus 500 in a clockwise or counterclockwise direction after the core deflector or disruptor 340 (see FIG. 19). Like the first fire extinguishment apparatus 100, the second fire extinguishment apparatus 500 could also include a second rifled grooved section in the first chamber segment 260 directing the dry chemical in the opposite direction from the first rifled section for further deflection of the flow of the dry chemical to enhance separation of the dry chemical from the high pressure air flow.

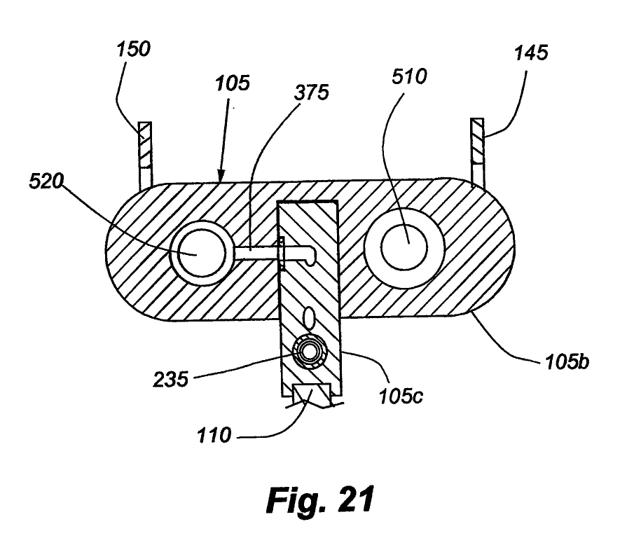

Similar to the first fire extinguishment apparatus 100, the housing 105 for the second fire extinguishment apparatus 500 may further define a clean agent-dry chemical passage 375 that extends from a clean agent passage 245 to a housing dry chemical passage 520 as shown, for example, in FIGS. 20 and 21. As described in more detail above in connection with the first fire extinguishment apparatus 100, the clean agent-dry chemical passage 375 allows the clean agent to flow from the clean agent passage 245 to the housing dry chemical passage 520 so that clean agent may flow through a dry chemical passage 525 defined by the dry chemical nozzle and discharged from the dry chemical nozzle 140 either independently or in combination with dry chemical.

The housing 105 for the second fire extinguishment apparatus 500 may further define a clean agent-water passage 530 that extends from the clean agent passage 245 to a water passage 510 defined by the housing 105. This clean agent-water passage 530 may be inserted to allow delivery of an agent, such as clean agent, to the water nozzle 120. The type of agent may be any suitable agent, including, but not limited to, clean agent, high pressure air for the creation of “Super CAF”, high pressure or ultra pressure water, foam, or a foam/water combination.

Like the first fire extinguishment apparatus 100, the second fire extinguishment apparatus 500 may include a clean agent-dry chemical valve 385 positioned within the clean agent-dry chemical passage 375. As described in more detail above with respect to the first fire extinguishment apparatus 100, the clean agent-dry chemical valve 385 may be a check valve or other one way valve that allows for the flow of material, such as the clean agent, from the clean agent passage 245 to the housing dry chemical passage 520 but prevents the flow of material in the opposite direction. The second fire extinguishment apparatus 500 may also include a clean agent-water valve 550 positioned within the clean agent-water passage 530. Like the clean agent-dry chemical valve 385, the clean agent-water valve 550 may be a check valve or other one way valve that allows for the flow of material, such as clean agent, from the clean agent passage 245 to the water passage 510 but prevents the flow of material in the opposite direction.

The second fire extinguishment apparatus 500, like the first fire extinguishment apparatus 100 may also include the switch 155. The switch 155 may be joined to a switch valve 535, such as a diverter valve or the like, that allows for communication between the clean agent hose 240 and the clean agent nozzle 130 to be selectively enabled and disabled by selectively aligning an outlet of the switch valve 535 with a clean agent port 540 in fluid communication with the clean agent nozzle 130 as shown, for example, in FIGS. 20A and 20B.

The switch 155 for the second fire extinguishment apparatus 500 could also be selectively positioned to allow for communication between the clean agent hose 240 and the dry chemical nozzle 140 or the water nozzle 120. More particularly, the switch 155 could be rotated or otherwise moved to a position that aligns the switch valve outlet with the clean agent-dry chemical passage 375 to allow such agents or other materials supplied via the clean agent hose 130 to pass through the switch valve 535 and into the clean agent-dry chemical passage 375 as shown, for example, in FIG. 20C. From the clean agent-dry chemical passage 375, such materials would flow through the dry chemical nozzle 140 and out the dry chemical outlet 195. Similarly, the switch 155 could be rotated or otherwise move to a position that aligns the switch valve outlet with the clean agent-water passage 530 to allow such agents or other materials supplied via the clean agent hose 130 to pass through the switch valve 535 and into the clean agent-water passage 530. From the clean agent-water passage 530, such materials would flow through the water nozzle 120 and out the water outlet 185.

The switch 155 for the second fire extinguishment apparatus 500 could also be moved to a position such that the switch valve outlet does not align with any of the passages or fluid conduits for the clean agent, dry chemical, or water nozzles 130, 140, 120. In such a position, clean agent or other materials flowing through the clean agent hose 240 would not be emitted from any of the nozzles 120, 130, 140, even when the trigger 115 was engaged to open the clean agent valve 215.

The second fire extinguishment apparatus 500 may include the water nozzle 120 threadedly or otherwise suitably joined to the housing 105, and the water handle 145 rotatably or otherwise movable joined to the housing 105. Like the water nozzle 120 for the first fire extinguishment apparatus 100, the water nozzle 120 for the second fire extinguishment apparatus 500 may include one or more fluid outlets 185. Similarly, the water handle 145 for the second fire extinguishment apparatus 500 may be configured to have similar components and to operate in a similar manner as described in more detail above for the first fire extinguishment apparatus 100.

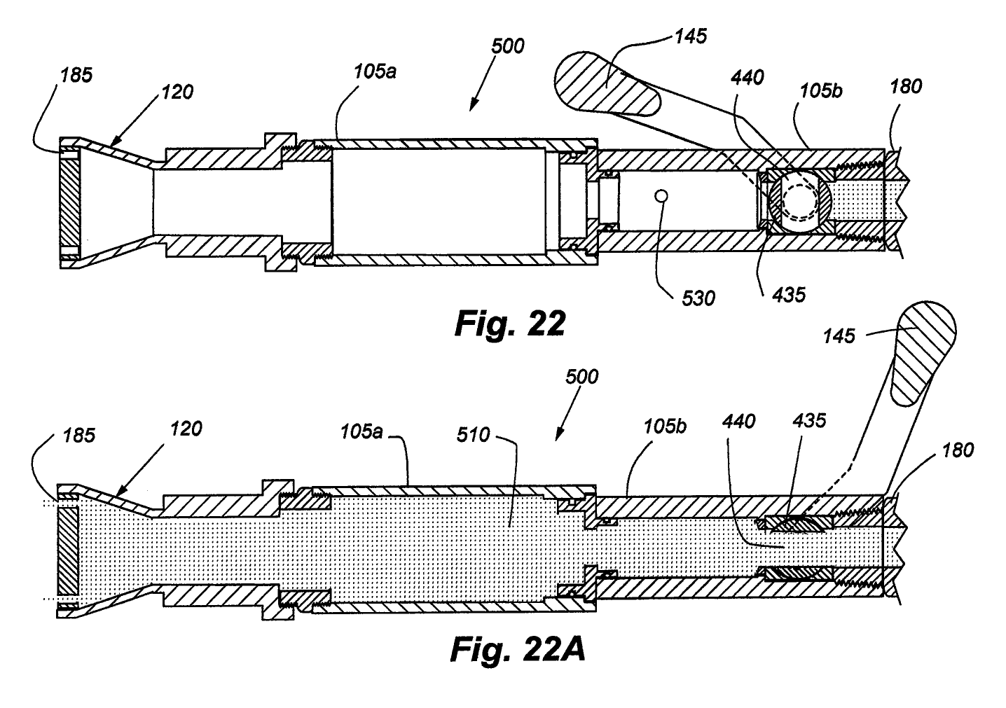

In particular, the water handle 145 of the second fire extinguishment apparatus 500 may be selectively rotated or otherwise moved relative to the housing 105 to open and close a water valve 435 joined to the water handle 145 as shown, for example, in FIGS. 22 and 22a. When the water valve 435 is opened as shown, for example, in FIG. 22a, water, foam, or water/foam flows from the fluid hose 180 or the like to the water nozzle 120 through the water passage 510 defined in the housing 105. When the water valve 435 is closed as shown, for example, in FIG. 22, fluid communication between the fluid hose 180 and water nozzle 120 is prevented. Also like the first fire extinguishment apparatus 100, the water valve 435 of the second fire extinguishment apparatus 500 may be moved to a position that allows the water, foam or water/foam to flow from the water outlets 185 defined by the water nozzle 120 at a restricted rate of discharge.

Similar to the first fire extinguishment apparatus 100, the fluid hose 180, a clean agent hose 230 and a dry chemical hose 330, or other material transportation conduits or the like, may be joined to the housing 105 of the second fire extinguishment apparatus 500. These hoses may be joined to the housing 105 by threaded connections or any other suitable connections.

FIG. 24 depicts a schematic view of a fire extinguishment system 600. The fire extinguishment system 600 may include a dry chemical system 605, a clean agent system 610, a water/foam system 615, a hose reel 620, and a fire extinguishment nozzle assembly 625. The first extinguishment nozzle assembly 625 may take the form of the fire extinguishment nozzle assembly 100 shown in FIGS. 1-9 and described above, the fire extinguishment nozzle assembly 500 shown in FIGS. 16-22 and described above, or any other suitable fire extinguishment nozzle assembly. The dry chemical system 605 may include one or more high pressure air bottles 630, the compensator 255, and a dry chemical source 190, such as a dry chemical tank. The clean agent system may include high pressure air bottles 635 and a clean agent source 160, such as a clean agent tank. In some embodiments, the clean agent system 610 may further include a pressurized water source. The water/foam system 615 may include a water source 165, a foam inject 640 and a high pressure air source 645.

The dry chemical tank 190 may contain dry chemical under pressure. The high pressure air bottles 630 may be operatively joined to the compensator 255. The compensator 255, in turn, may be operatively joined to the dry chemical tank 190. Dry chemical may be stored in the dry chemical tank 190 at ambient pressure or at high pressure. The dry chemical may be stored in the dry chemical tank 190 under a pressure of approximately 350-500 psi. A high pressure air source may be operatively associated with the dry chemical tank 190. High pressure air may be supplied to the dry chemical tank 190 in three or more directions to shear, fluff and fluidize the dry chemical. The dry chemical hose 330 may be placed in fluid communication with the dry chemical tank 190 to deliver dry chemical from the dry chemical tank 190 to the fire extinguishment apparatus 625. At least a portion of the dry chemical hose 330 may be wrapped around the hose reel 620. Agents may be delivered from the dry chemical source 190 to the fire extinguishment nozzle assembly 625 through hose lengths from less than 1 foot to greater than 200 feet.

The clean agent storage tank 160 may contain clean agent under pressure. The clean agent high pressure air bottles 635 may be operatively joined to the clean agent tank 160. Air may be delivered to the clean agent tank 160 from the high pressure clean agent air bottles 635 for storage in the clean agent tank 160. The clean agent tank 160 may be maintained at a pressure of approximately 350-500 psi. The clean agent hose 240 may be placed in fluid communication with the clean agent tank 160 to deliver clean agent from the clean agent tank 160 to the fire extinguishment nozzle assembly 625. At least a portion of the clean agent hose 240 may be wrapped around the hose reel 620.

The water source 615 may be in fluid communication with the water hose 180 and/or with the clean agent hose 240 to deliver water from the water source 165 to the fire extinguishment apparatus 625. The water source 165 may be a high pressure water tank. In some embodiments, the water source 165 may not be a high pressure water tank. In such embodiments, a pump, a standard pressure tank or the like may be operatively associated with water source 165 to deliver water under pressure to the fire extinguishment apparatus 625 via the water nozzle 120 and/or the clean agent nozzle 130. The foam inject 640 may be operatively associated with water hose 180 (or other conduit for delivering water to the fire extinguishment apparatus 625) to inject foam into water delivered to the fire extinguishment apparatus 625. The foam may be injected before or after the injection of high pressure air into the water. Injection of the high pressure air creates a compressed air foam. At least a portion of the water hose 180 may be wrapped around the hose reel 620. Premixed foam water may be delivered as an alternative to foam injection.

At the hose reel 620, the fluid hose 180, the clean agent hose 240, and the dry chemical hose 330 may be bundled. Such bundling may facilitate handling the hoses 180, 240, 330 between the fire extinguishment apparatus 625 and the hose reel 620. Such bundling may also reduce the potential for the hoses 180, 240, and 330 to become entangled with each other. While the hoses 180, 240, 330 are schematically depicted as bundled in FIG. 24, bundling of the hoses 180, 240, 330 is optional.

Operation of the fire extinguishment system 600 will now be described with reference to FIGS. 1-9 and 24. While described with reference to FIGS. 1-9, operation of a fire extinguishment system 600 for the fire extinguishment nozzle system 500 shown in FIGS. 16-23 would be to similar to operation of a fire extinguishment system 600 that uses the fire extinguishment nozzle assembly 100 shown in FIGS. 1-9.

A dry chemical system 605, a clean agent system 610, and a water/foam system 615 may be placed in communication with a fire extinguishment apparatus 100 via dry chemical, clean agent, and water hoses 330, 240, 180, respectively. Dry chemical flows from the dry chemical system 605 to the fire extinguishment apparatus 100 via the dry chemical hose 330. Similarly, clean agent and/or water flows from the clean agent system 610 to the fire extinguishment apparatus 100 via the clean agent hose 240, and water or water/foam flows from the water/foam system 615 to the fire extinguishment apparatus 100 via the water hose 180.

The dry chemical handle 150 may be rotated relative to the housing 105 to open and close the dry chemical valve 360. When opened, dry chemical flows from the dry chemical hose 330 to the dry chemical outlet 195 via the dry chemical nozzle 140. As the dry chemical flows through the dry chemical nozzle 140, a disruptor 340 may be employed to deflect the dry chemical towards an inner surface of the first chamber segment 260 and cause the dry chemical to rotate. The configuration of the dry chemical passage in the dry chemical nozzle 140 disrupts the flow of material through the dry chemical nozzle and creates a turbulent environment within the dry chemical nozzle that facilitates polarization of the dry chemical and separation of high pressure air from the dry chemicals as the dry chemical flows through the dry chemical nozzle. Such disruptions and turbulence allows the dry chemical stream to be discharged from the dry chemical outlet 195 in a consolidated stream at speeds approaching mach 1. Polarization conditions the dry chemical to a charge that is opposite the charge of the fire plasma or the anionic and free radicals surrounding the fire plasma, thus rapidly attracting the dry chemical to the heart of the fire. A rifled section 255 clockwise or counterclockwise may be inserted after the deflection assembly or disruptor 340 to create additional separation. Additional rifling segments may be used to further increase separation of the dry chemical from the high pressure air.

The water handle 145 may be rotated relative the water conduit connector 175 (or the housing 105) to open and close the water valve 435. When opened, water or water/flow flows from the water hose 180 to the water outlet 185 (or outlets) via the fluid chamber or passage 380 and the water nozzle 120. As water or water/foam flows from the fire extinguishment apparatus 100 via the water outlets 185, the water or water/foam may substantially encompass the dry chemical flow exiting the dry chemical outlet 195. In some embodiments, deflectors or other suitable structures may be associated with the water outlet or outlets 185 to cause the water or water/foam to partially encompass the dry chemical flow and/or to mix with the dry chemical. In still yet other embodiments, the water outlet or outlets 185 may be configured, and/or associated with deflectors or the like, to deliver the water or water/foam and clean agent side-by-side with the dry chemical flow.

The trigger 115 may be pressed towards the handle 110 to open the clean agent valve 215. When the clean agent valve 215 is opened, clean agent and/or water may flow to either the dry chemical nozzle 140 to mix with dry chemical flowing through the dry chemical nozzle 140 or flow independently from the fire extinguishment apparatus 100 via the clean agent outlet 170 or the dry chemical outlet 195.

The dry chemical valve 360, the water valve 435, and the clean agent valve 215 may be opened concurrently so that dry chemical, water or water/foam or Compressed Air Foam (“CAF”), and clean agent or clean agent/water flows concurrently from the fire extinguishment apparatus 100. Other combinations of open and closed valves, however, are possible so that one or more of the dry chemical, water or water/foam or CAF, and the clean agent or clean agent/water may exit the fire extinguishment apparatus 100 at any time. For example, the dry chemical and the water valves 360, 435 may be opened and the clean agent valve 215 closed so that only the dry chemical and the water or water/foam or CAF are discharged from the fire extinguishment apparatus 100. As another example, the dry chemical valve 360 may be opened and the water and clean agent valves 435, 215 closed so that only the dry chemical is discharged from the fire extinguishment apparatus 100. The foregoing examples are merely illustrative and are not intended to imply any particular arrangement of opened and closed valves.

A dry chemical nozzle as described above with respect to the fire extinguishment nozzle assemblies 100, 500 shown in FIGS. 1-9 and 16-22 was tested to assess the ability of this dry chemical nozzle to discharge polarized dry chemical. The test involved delivering a substantially non-polarized dry chemical to the nozzle at 425 psi from a DC tank to the nozzle through a 15 foot, ⅞″ diameter hose. The measured charge on the dry chemical exiting the dry chemical nozzle was over 100 kilovolts (kV). There were also visible photonics at the discharge end of the dry chemical nozzle during this test, which is consistent with the measured charge on the dry chemical. This test was also conducted at 230 psi, which represents the standard operation pressure for typical straight bore dry chemical nozzles. At this lower pressure, the maximum measured charge was 20 kV. Thus, at pressures greater than 250 psi, a substantial electrostatic charge (i.e., greater than approximately 30 kV) can be measured and observed for dry chemical discharged from the dry chemical nozzle.

For a comparison of the dry chemical nozzle to a conventional dry chemical nozzle, a straight bore nozzle, such as a HydroChem™ nozzle, with a 0.505″ inner diameter was also tested. This test involved delivering a substantially non-polarized dry chemical to the nozzle at 230 psi, the standard operation pressure for this delivery technology, from a DC tank to the straight bore nozzle through a 15 foot, ⅞″ diameter hose. The measured charge on the dry powder exiting the straight bore nozzle was 20 kV or less. The straight bore nozzle was not tested at 425 psi since the pressurization system for this nozzle provides only for safe operating pressures up to about 250 psi. While not directly tested, the straight bore nozzle was indirectly tested at 425 psi. In another test, a 1″ inner diameter straight bore nozzle was tested by delivering substantially non-polarized dry chemical at 425 psi through a 1″ diameter hose using a high pressure delivery system. While no electrostatic measurements were made during this test, a photonic glow was not observed at the discharge end of the nozzle. This lack of photonic glow indicates that the dry chemical was not being substantially charged.

With respect to the dry chemical nozzle shown and described in U.S. Pat. No. 5,344,077, this nozzle is incorporated into products such as the QUADAGENT® delivery system sold by Advanced Fire Control Technologies, Inc. The dry chemical nozzle for the QUADAGENT® delivery system operates at pressures from 400 to 425 psi. When operated at these pressures, photonics were not observed in the original filming of the pulses within the dry chemical stream in 1994 and have not been observed at the discharge end of the nozzle over many years of night testing and use, which indicates that the dry chemical is not being substantially charged. Further, while electrostatic discharges have been experienced when operating the nozzle at these pressures, the discharges have been the equivalent to carpet discharges, which are generally in the range of 5 kV.

The fire extinguishment system and nozzle assemblies are designed for use on numerous types and configurations of fire. The clean agents, dry chemicals and fluids used in the fire extinguishment system and discharged from the fire extinguishment nozzle assemblies may be selected based on the type of fire and the availability of these materials. Accordingly, the present invention is not limited to the types of fires that may be extinguished using the fire extinguishment system and nozzle assemblies described herein nor is it limited to use of particular clean agents, dry chemicals or liquids. Further, the fire extinguishment nozzle assemblies may be scaled.

All directional references (e.g., upper, lower, upward, downward, left, right, leftward, rightward, top, bottom, above, below, inner, outer, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and/or in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

In methodologies directly or indirectly set forth herein, various steps and operations are described in one possible order of operation, but those skilled in the art will recognize that steps and operations may be rearranged, replaced, or eliminated or have other steps inserted without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A fire extinguishment nozzle assembly, comprising:
a nozzle comprising:
a first chamber segment including an inlet configured to receive a dry chemical and an outlet, the first chamber segment defining a dry chemical passage extending from the inlet to the outlet;
a first collar positioned proximate the outlet of the first chamber segment, the first collar including an inlet side and an outlet side and defining a first aperture extending from the inlet side to the outlet side with the first aperture larger at the inlet side than at the outlet side; and
the first aperture is in fluid communication with the outlet of the first chamber segment.

2. The fire extinguishment nozzle assembly of claim 1, wherein the dry chemical passage includes a first cross-sectional area proximate the inlet and a second cross-sectional area proximate the outlet with the first cross-sectional area smaller than the second cross-sectional area.

3. The fire extinguishment nozzle assembly of claim 2, wherein the nozzle comprises:
a second chamber segment including an inlet and an outlet, the second chamber segment defining a second dry chemical passage extending from the inlet to the outlet of the second chamber segment,
a second collar positioned proximate the outlet of the second chamber segment, the second collar including an inlet side and an outlet side and defining a second aperture extending from the inlet side to the outlet side of the second collar with the second aperture larger at the inlet side of the second collar than at the outlet side of the second collar;
the first aperture is in fluid communication with the inlet of the second chamber segment; and
the second aperture is in fluid communication with the outlet of the second chamber segment.

4. The fire extinguishment nozzle assembly of claim 3, wherein the second dry chemical passage includes a first cross-sectional area proximate the inlet and a second cross-sectional area proximate the outlet with the first cross-sectional area of the second dry chemical passage smaller than the second cross-sectional area of the second dry chemical passage.

5. The fire extinguishment nozzle assembly of claim 3, wherein:
the first dry chemical passage defines a first volume;
the second dry chemical passage defines a second volume; and
the first volume is greater than the second volume.

6. The fire extinguishment nozzle assembly of claim 5, wherein the nozzle comprises a third chamber segment, the third chamber segment defining a third dry chemical passage in fluid communication with the second dry chemical passage, the third dry chemical passage defining a third volume, and the second volume is greater than the third volume.

7. The fire extinguishment nozzle assembly of claim 3, wherein the nozzle comprises:
a third chamber segment including an inlet and an outlet, the third chamber segment defining a third dry chemical passage extending from the inlet to the outlet of the third chamber segment,
a third collar positioned proximate the outlet of the third chamber segment, the third collar including an inlet side and an outlet side and defining a third aperture extending from the inlet side to the outlet side of the third collar with the third aperture larger at the inlet side of the third collar than at the outlet side of the third collar; and
the second aperture is in fluid communication with the inlet of the third chamber segment; and
the third aperture is in fluid communication with the outlet of the third chamber segment.

8. The fire extinguishment nozzle assembly of claim 7, wherein the third dry chemical passage includes a first cross-sectional area proximate the inlet and a second cross-sectional area proximate the outlet with the first cross-sectional area of the third dry chemical passage smaller than the second cross-sectional area of the third dry chemical passage.

9. A fire extinguishment nozzle assembly, comprising:
a nozzle configured such that a substantially non-polarized dry chemical delivered from a dry chemical source to the nozzle at a pressure greater than approximately 250 pounds per square inch exits the nozzle with a charge of at least approximately 30,000 volts.

10. The fire extinguishment nozzle assembly of claim 9, wherein the dry chemical is polarized to have a negative charge.

11. The fire extinguishment nozzle assembly of claim 9, wherein the dry chemical is polarized to have a positive charge.

12. The fire extinguishment nozzle assembly of claim 9, wherein the nozzle comprises:
two chamber segments defining at least a portion of a dry chemical passage; and
a collar positioned between the two chamber segments and defining an aperture that enables fluid communication between the at least two chamber segments.

13. The fire extinguishment nozzle assembly of claim 12, wherein the aperture decreases in size from a first end to a second end of the collar.

14. The fire extinguishment nozzle assembly of claim 12, wherein the collar comprises stainless steel, and at least one of the two chamber segments comprises aluminum.

15. The fire extinguishment nozzle assembly of claim 9, further comprising:
a housing that at least partially contains the nozzle; and
a second nozzle connected to housing, the second nozzle defining a second fluid passage configured to receive at least water therethrough.

16. The fire extinguishment nozzle assembly of claim 15, further comprising a third nozzle connected to the housing, the third nozzle defining a third fluid passage configured to receive at least a clean agent therethrough.

17. A fire extinguishment nozzle assembly, comprising:
a first nozzle configured to deliver dry chemical in a consolidated dry chemical stream from the first nozzle; and
a second nozzle configured to deliver a water stream that selectively at least partially encompasses the consolidated dry chemical stream.

18. The fire extinguishment nozzle assembly of claim 17, wherein the second nozzle defines a fluid passage and the first nozzle is at least partially contained within the fluid passage.

19. The fire extinguishment nozzle assembly of claim 17, wherein the first nozzle comprises:
a chamber segment including an inlet configured to receive a dry chemical and an outlet, the chamber segment defining a dry chemical passage extending from the inlet to the outlet;
a collar positioned proximate the outlet of the chamber segment, the collar including an inlet side and an outlet side and defining an aperture extending from the inlet side to the outlet side with the aperture larger at the inlet side than at the outlet side; and
the aperture is in fluid communication with the outlet of the chamber segment.

20. A fire extinguishment apparatus, comprising:
a housing;
a first nozzle at least partially contained within the housing, the first nozzle configured to deliver at least a dry chemical;
a second nozzle operatively associated the housing, the second nozzle configured to deliver at least water; and
a third nozzle operatively associated with the housing, the third nozzle configured to deliver at least a clean agent.

21. The fire extinguishment apparatus of claim 20, wherein the first nozzle comprises at least three chamber segments, each chamber segment defining a chamber, and each chamber in fluid communication with at least one other chamber.

22. The fire extinguishment apparatus of claim 21, wherein the first nozzle further comprises a collar positioned between two of the at least three chamber segments, the collar including an aperture enabling fluid communication between the chambers of the two of the at least three chamber segments.

23. The fire extinguishment apparatus of claim 22, wherein at least one of the three chamber segments comprises aluminum, and the collar comprises stainless steel.

24. The fire extinguishment apparatus of claim 21, wherein at least one of the at least three chamber segments includes a multi groove rifling section.

25. The fire extinguishment apparatus of claim 21, further comprising a disruptor positioned proximate an inlet portion of one of the at least one chamber segments.

26. The fire extinguishment apparatus of claim 20, further comprising a first passage in fluid communication with the third nozzle and configured to receive the clean agent.

27. The fire extinguishment apparatus of claim 26, further comprising a second passage fluidly joining the first passage to a dry chemical passage defined by the first nozzle.

28. The fire extinguishment apparatus of claim 27, further comprising a valve positioned in the second passage, the valve allowing the clean agent to flow from the first passage to the dry chemical passage.

29. The fire extinguishment apparatus of claim 20, further comprising a high pressure air source operatively associated with the second nozzle.

30. A fire extinguishment system, comprising:
a fire extinguishment apparatus;
a dry chemical system comprising a pressurized dry chemical tank operatively associated with the fire extinguishment apparatus;
a clean agent system comprising a clean agent tank operatively associated with the fire extinguishment apparatus; and
a water system comprising a water source operatively associated with the fire extinguishment apparatus.

31. The fire extinguishment system of claim 30, further comprising a dry chemical hose operatively associated with the pressurized dry chemical tank and the fire extinguishment apparatus.

32. The fire extinguishment system of claim 31, wherein the fire extinguishment apparatus includes a dry chemical nozzle operatively associated with the dry chemical hose, and at least one of the dry chemical hose or dry chemical nozzle configured to polarize dry chemical flowing therethrough.

33. The fire extinguishment system of claim 30, wherein the water system further comprises:
a water hose operatively associated with the water source and the fire extinguishment apparatus, and
a foam injector operatively associated with the water hose.

34. The fire extinguishment system of claim 30, wherein the pressurized dry chemical tank is maintained at a pressure between approximately 250 and 500 psi.

35. The fire extinguishment system of claim 30, wherein the dry chemical system further comprises at least one high pressure air bottle operatively associated with the pressurized dry chemical tank.

36. The fire extinguishment system of claim 30, wherein the clean agent system further comprises at least one high pressure air bottle operatively associated with the clean agent tank.
